(19) United States
(12) Patent Application Publication
(10) Pub. No.: US 2019/0217559 A1
(43) Pub. Date: Jul. 18, 2019

(54) Pultrusion Process and Arrangement for the Continuous Production of Blanks from a Fibre-Plastic Composite Material

(71) Applicant: Thyssenkrupp Carbon Components GmbH, Kesselsdorf (DE)

(72) Inventors: Jens Werner, Coswig (DE); Andre Kiessling, Klipphausen (DE); Jörn Kiele, Dresden (DE); Till Weinkauf, Dresden (DE)

(21) Appl. No.: 16/331,963

(22) PCT Filed: Sep. 29, 2017
(86) PCT No.: PCT/EP2017/074869

§ 371 Date: Mar. 9, 2019

(30) Foreign Application Priority Data
Oct. 7, 2016 (DE) 10 2016 219 553.0

(51) Int. Cl. B29C 70/52; B29C 70/54

(52) U.S. Cl. CPC B29C 70/523; B29C 70/545; B29C 70/525

(57) ABSTRACT

The invention relates to a pultrusion process for the continuous production of blanks from a fibre-plastic composite material (23), an arrangement for carrying out a pultrusion process and use of the pultrusion process according to the invention and the arrangement according to the invention. The pultrusion process comprises at least the following process steps:
i. providing a strand of unimpregnated fibres (21);
ii. feeding the strand of unimpregnated fibres (21) to a vacuum device (5, 5′, 5″), which has at least one vacuum chamber (52, 52′, 52″);
iii. generating a negative relative pressure in the at least one vacuum chamber (52, 52′, 52″) of the vacuum device (5, 5′, 5″), whereby air (200) escapes from the strand of unimpregnated fibres (21);
iv. removing the almost airless strand of unimpregnated fibres (22) from the vacuum device (5, 5′, 5″) and feeding the almost airless strand of unimpregnated fibres (22) to an injection device (6, 6′), which has at least one injection chamber (61, 61′), wherein the vacuum device (5, 5′, 5″) and the injection device (6, 6′) are connected to one another in an airtight manner, at least with respect to the surroundings;
v. injecting matrix material (230) in a flowable state into the at least one injection chamber (61, 61′) of the injection device (6, 6′) and impregnating the strand (2) with the matrix material (230);
vi. removing of the blank (23) from the injection device (6, 6′). With the process according to the invention, a homogeneous and complete wetting of the fibres of the strand is advantageously achieved at a high drawing rate. Furthermore, the fibre-plastic composite is not pressed in the process.

### CROSS REFERENCE TO RELATED APPLICATIONS

This application is the U.S. national stage of International Application No. PCT/EP2017/074869, filed on 2017 Sep. 29. The international application claims the priority of DE 102016219553.0 filed on 2016 Oct. 7; all applications are incorporated by reference herein in their entirety.

### BACKGROUND

The invention relates to a pultrusion process for the continuous production of blanks from a fibre-reinforced plastics composite material (FRP), an arrangement for carrying out a pultrusion method for the continuous production of blanks from a fibre-reinforced plastics composite material, and the use of the pultrusion process according to the invention and of the arrangement according to the invention.

The pultrusion process allows for continuous manufacture of fibre-reinforced plastics composite profiles (FRP profiles), in particular of composite profiles reinforced with continuous fibres. During the pultrusion process, a strand of (reinforcing) fibres and/or semi-finished fibre products, in particular consisting of continuous reinforcing fibres, is drawn, by means of a draw-off device, through a device for producing a FRP profile which generally comprises a device for embedding the fibres in a plastics matrix, also known as impregnation, and a curing and shaping device. The process speeds of the individual process steps of the pultrusion process determine the drawing speed, i.e. the speed at which the strand is drawn through the device in order to carry out the pultrusion process. A strand refers to the arrangement of semi-finished fibre products that passes through the process steps of the pultrusion process.

The shaping is generally carried out by means of a heated tool, in which the matrix material of the FRP profile is simultaneously cured. Since the curing requires a certain amount of time, the drawing speed that can be used in the case of a pultrusion process using a heated tool is restricted. In order to increase the drawing speed, the heated tool can be lengthened while the tool temperature is kept constant, such that the residence time of the strand, impregnated with matrix material, in the tool is extended. Lengthening the tool disadvantageously leads to an increase in the friction to which the strand is subjected, resulting in higher draw-off forces that must be applied by the draw-off device and a greater likelihood of the fibres of the strand being damaged. In addition, acceleration of the curing process can be achieved by increasing the tool temperature while the tool length is kept constant. A disadvantage in this case is that, in particular in the case of large strand cross sections, the temperature distribution is not homogenous, frequently resulting in locally restricted partial curing in the tool or premature curing of the surface of the strand, which may lead to ripping of the surface or blistering on the surface following emergence from the tool. Furthermore, possible local overheating of the matrix material may result in the chemical decomposition thereof.

EP 1347114 A2 discloses a pultrusion process in which the process steps of shaping and of curing are mutually separated in order to overcome the described disadvantages. For this purpose, shaping permanent formwork, consisting of plastics material, is used, in which formwork the curing can take place independently of the pultrusion process itself. The permanent formwork is filled and closed in a simple manner, in the pultrusion process, by means of fibres that are impregnated with matrix material. No measures are described by means of which incomplete impregnation of the fibres or air pockets during impregnation are prevented, and therefore it should be assumed that the FRP profiles produced by means of the disclosed method have a reduced quality.

The aim of the impregnation step is to fully encase every element of the semi-finished fibre product in matrix material. Incompletely wetted elements and air pockets in the matrix adversely affect the mechanical properties of a FRP profile, and are undesirable. For this reason, the impregnation is frequently carried out by means of injecting the matrix material at a significantly increased relative pressure, the relative pressure being the pressure difference between the absolute pressure prevailing in the apparatus and the ambient pressure (generally the air pressure). However, this pressure increase is not sufficient, in particular in the case of matrix materials having a higher viscosity, to prevent the undesired effects mentioned. Various further approaches for improving the quality of saturation of a strand by matrix material are known from the prior art. U.S. Pat. No. 5,073,413 A describes a pultrusion process in which matrix material is first injected into a strand of unsaturated fibres, and subsequently the strand of now saturated fibres undergoes a degassing process in which it is drawn through a chamber in which a negative relative pressure (subatmospheric pressure) prevails. A disadvantage of this solution is that the matrix material constitutes increased flow resistance for air bubbles that are intended to escape from the inside of the fibre strand in the radial direction. In particular in the case of strands having large cross sections, the residence time in the low-pressure chamber consequently has to be long in order to achieve a low drawing speed through the pultrusion apparatus.

A similar concept for a pultrusion process is disclosed in JP H05318608 A. In this case, the strand is saturated by means of injecting matrix material from at least two points, between which the already saturated strand is subjected to a negative pressure in order for air bubbles trapped during the first saturation process to escape from the strand. This process is also associated with the above-mentioned disadvantages owing to the flow resistance for trapped air bubbles which is increased by the matrix material.

### SUMMARY

The invention relates to a pultrusion process for the continuous production of blanks from a fibre-plastic composite material (23), an arrangement for carrying out a pultrusion process and use of the pultrusion process according to the invention and the arrangement according to the invention. The pultrusion process comprises at least the following process steps:

i. providing a strand of unimpregnated fibres (21);

ii. feeding the strand of unimpregnated fibres (21) to a vacuum device (5, 5′, 5″), which has at least one vacuum chamber (52, 52′, 52″);

iii. generating a negative relative pressure in the at least one vacuum chamber (52, 52′, 52″) of the vacuum device (5, 5′, 5″), whereby air (200) escapes from the strand of unimpregnated fibres (21);

iv. removing the almost airless strand of unimpregnated fibres (22) from the vacuum device (5, 5′, 5″) and feeding the almost airless strand of unimpregnated fibres (22) to an injection device (6, 6′), which has at least one injection chamber (61, 61′), wherein the vacuum device (5, 5′, 5″) and the injection device (6, 6′) are connected to one another in an airtight manner, at least with respect to the surroundings;

v. injecting matrix material (230) in a flowable state into the at least one injection chamber (61, 61′) of the injection device (6, 6′) and impregnating the strand (2) with the matrix material (230); vi. removing of the blank (23) from the injection device (6, 6′). With the process according to the invention, a homogeneous and complete wetting of the fibres of the strand is advantageously achieved at a high drawing rate. Furthermore, the fibre-plastic composite is not pressed in the process.

### DETAILED DESCRIPTION

The object of the present invention is therefore that of overcoming the disadvantages of the prior art and proposing a pultrusion process by means of which higher drawing speeds are achieved without negatively influencing the mechanical properties of the fibre-reinforced plastics composite blank produced by means of the process.

This object is achieved by a pultrusion process having the features of claim 1. The pultrusion process according to the invention for continuous production of a blank from fibre-reinforced plastics composite material comprises at least the following process steps, the process steps being carried out in the specified sequence:
i. providing a strand of unsaturated fibres, the term “fibres” also including all suitable semi-finished products made of fibres;
ii. feeding the strand of unsaturated fibres to a vacuum unit that comprises at least one vacuum chamber;
iii. generating a negative relative pressure in the at least one vacuum chamber of the vacuum unit, as a result of which air escapes from the strand of unsaturated fibres;
iv. removing the virtually evacuated strand of unsaturated fibres from the vacuum unit and feeding the virtually evacuated strand of unsaturated fibres to an injection unit that comprises at least one injection chamber, the vacuum unit and injection unit being interconnected so as to be airtight with respect to the surroundings;
v. injecting matrix material, in fluid state, into the at least one injection chamber of the injection unit, and impregnating the strand with the matrix material;
vi. removing the blank from the injection unit.

Following removal from the injection unit, the blank can be fed to further process steps which relate inter alia at least to the curing of the matrix material. Owing to the fact that the strand of unsaturated fibres is exposed to a negative relative pressure prior to impregnation and is therefore virtually evacuated upon impregnation, the process according to the invention can advantageously achieve homogenous and full wetting of the fibres of the strand at a high drawing speed.

A further advantage of the process according to the invention is that there is no need to change the fibre volume ratio of the strand during the course of the process, for example by means of pressing. It is advantageously also possible to produce FRP blanks having a fibre volume ratio that is favourable for the strength of the cured FRP blank, for example a fibre volume ratio of less than 60 vol. %, by means of the process according to the invention.

The pultrusion process according to the invention is suitable for producing solid FRP blanks or FRP blanks in the form of hollow profiles. The pultrusion process according to the invention is furthermore suitable for producing FRP blanks having various geometric cross-sectional shapes, for example round solids or hollow profiles, oval, in particular as solids, or polygonal, in particular also in a C-, H-, I-, L- or T-profile shape, the cross section of the FRP blank being constant.

Individual filaments and rovings, in particular continuous fibres, as well as any semi-finished fibre product suitable for pultrusion, for example non-woven fabrics, knitted fabrics, woven fabrics, braided fabrics, mats, unbonded webs, and combinations of different fibre types or semi-finished fibre product types can be used for the process according to the invention. Natural or synthetic fibres, for example glass or carbon or aramid fibres, or mixtures of different fibre types, can be used.

In principle both thermosetting plastics and thermoplastics can be used as the matrix material. Reactive resin systems or fusible plastics materials are particularly preferably used as the matrix material.

Within the meaning of the invention, a “strand” refers to all bundled fibres or semi-finished fibre products that pass through the process steps of the pultrusion process according to the invention. Within this meaning, the term “strand” also includes an arrangement of bundled fibres or semi-finished fibre products and a mould core, as is used for producing a hollow profile.

Within the meaning of the invention, “unsaturated fibres” are fibres or semi-finished fibre products that are not wetted with matrix material. The unsaturated fibres are provided and are fed to the process steps of the process according to the invention from a supply region which may for example comprise a creel and/or a weaving wheel and/or a winding wheel and/or a rack for material strips. Following draw-off out of the supply region, the fibres are bundled into a strand.

The vacuum unit is designed such that a negative relative pressure acts on the strand of unsaturated fibres in the at least one vacuum chamber of said unit, “negative relative pressure” meaning, within the meaning of the invention, that the absolute pressure prevailing in the at least one vacuum chamber of the vacuum unit is lower than the ambient pressure prevailing in the supply region, i.e. in general is lower than air pressure. An absolute pressure is preferably established in the at least one vacuum chamber of the vacuum unit, which absolute pressure is to be classified as being in the low vacuum range. The negative relative pressure can be generated by means of one or more vacuum pumps, in particular types of vacuum pumps being used which are suitable for operation in the low vacuum range, for example piston pumps or rotary vane pumps or scroll pumps or water-jet pumps. For this purpose, the vacuum unit comprises at least one connection having access to the at least one vacuum chamber, which connection is suitable for connecting one or more vacuum pumps.

Air is largely removed from the strand of unsaturated fibres in the at least one vacuum chamber of the vacuum unit. In this case, the residual air content in the strand of unsaturated fibres upon removal from the vacuum unit is a function of the absolute pressure in the at least one vacuum chamber of the vacuum unit. Within this meaning, the strand of unsaturated fibres is to be denoted “virtually evacuated” upon removal from the vacuum unit.

In a following process step, the virtually evacuated strand of unsaturated fibres is removed from the vacuum unit and fed to an injection unit. The vacuum unit and the injection unit are arranged in succession in the pultrusion direction and comprise a continuous strand channel. Within the meaning of the invention, a “strand channel” refers to the region of a unit in which the strand is arranged. The strand channel preferably extends in a break-free manner at least over the entire length of the two units. Within the meaning of the invention, the “pultrusion direction” refers to the direction of passage through the units for carrying out the process according to the invention. In the following, unless otherwise indicated all position specifications relate to the pultrusion direction.

Removal from the vacuum unit and feeding to the injection unit takes place in a continuous manner by means of a draw-off unit which will be explained below. The vacuum unit and injection unit are interconnected so as to be airtight at least with respect to the surroundings.

Within the meaning of the invention “airtight” means that the penetration of ambient air is prevented or at least limited to a level that does not impair the process. The level of ambient air penetrating the strand, which level is a function of the leakage rate in the units of the pultrusion process according to the invention and the connecting regions of the units does not impair the process if it does not lead to a formation of air pockets and pores, during impregnation of the strand in the pultrusion process, that negatively impairs the mechanical properties of the cured FRP blank. Within the meaning of the invention, “air tightness” includes tightness at least to non-aggressive fluids.

The injection unit comprises at least one injection chamber. Matrix material is injected, in a fluid state, into the at least one injection chamber of the injection unit, in order to infiltrate and impregnate the virtually evacuated strand, guided from the vacuum unit into the injection unit, with matrix material.

Owing to the fact that the strand is virtually evacuated upon impregnation, the impregnation takes place in this case in particular in the case of full wetting of the fibres, such that the surface of the strand is fully saturated with matrix material upon leaving the injection unit such that substantially no air from the surroundings can penetrate into the FRP blank when the FRP blank is removed from the injection unit. In other words, provided that the surface of the FRP blank is not subjected to any deformation, in particular bending or stretching, in the process according to the invention substantially no pore channels, through which air can penetrate into the inside of the FRP blank, form following impregnation.

Following removal from the injection unit, the FRP blank can be fed to further process steps, inter alia at least for curing the matrix material.

According to a preferred embodiment of the pultrusion process according to the invention, the following process steps follow process step vi.:
vii. feeding the blank to a coating unit;
viii. forming a coated surface of the blank in the coating unit, the coating being designed to ensure the air tightness of the surface of the blank during further process steps which the blank may undergo;
ix. removing the blank, comprising the coating, from the coating unit.

Following removal from the coating unit, the blank can be fed to further process steps which may relate inter alia to machining to shape and to the curing of the matrix material.

The embodiment described advantageously allows for further processing of the blank comprising a coating, in particular non-cutting shaping, without it being possible for air to penetrate into the blank due to damage to the surface of the blank.

In this case, within the meaning of the invention, “coating” is to be understood to mean all intrinsic and/or extrinsic elements by means of which the blank is provided with a surface that remains airtight during further processing of the blank. Possible further processing is in particular non-cutting shaping, in which portions of the surface of the blank are compressed or stretched for example. Intrinsic elements are to be understood as elements which consist of matrix material. Within this meaning, intrinsic elements are in particular partially consolidated or matrix material in glassy state. Extrinsic elements are elements different from the matrix material, for example films or waxes.

In a further preferred embodiment of the pultrusion process according to the invention, either, following process step vi., the blank, or, following process step ix., the blank comprising a coating, passes through a cutting unit. The blank or the blank comprising a coating is cut to length in the cutting unit.

The cutting to length in the cutting unit can take place temporally significantly later than the preceding process steps. For the purpose of temporary storage, the FRP blank produced by means of the pultrusion process according to the invention can then for example be wound onto a coil and fed to a cooling step, if necessary, in order to delay curing of the matrix material until the FRP blank is fed to further process steps.

The strand is fed to the described units for carrying out the pultrusion process according to the invention by means of a draw-off unit, the strand passing through the draw-off unit at least downstream of the injection unit and upstream of the cutting unit. All suitable devices known from the prior art, for example a puller or a strip haul-off unit, can be used as the draw-off unit. Owing to the fact that the matrix material of a FRP blank produced by means of the process according to the invention does not yet have to be cured when passing through the draw-off unit, it is also possible to use a drum haul-off unit, for example, as the draw-off unit.

The strand is preferably fed to the described units for carrying out the pultrusion process according to the invention in a uniform and continuous manner.

If a blank produced by means of the pultrusion process according to the invention is intended to undergo shaping, this is carried out after forming a coated surface and cutting to length, or after cutting to length and forming a coated surface.

Curing of the matrix material advantageously takes place spatially and temporally separately from the pultrusion process according to the invention. If no further processing of the blank different from cutting to length is intended to take place following process step vi., in particular no shaping, the blank can be cured before or after cutting to length, without the surface of the blank being coated. If further processing, in particular shaping, is intended to take place, the curing preferably takes place after forming a coated surface and cutting to length, or after cutting to length and forming a coated surface, and after or during the shaping process. The matrix material may be cured before or after passing through the draw-off unit.

The sequence of further process steps which follow the pultrusion process according to the invention and at least relate to the process of passing through the draw-off unit, the cutting to length and the curing of the matrix material, can be varied.

Various embodiments of the pultrusion process according to the invention will be described in the following, which embodiments relate to the process steps in the vacuum unit.

In a preferred embodiment of the pultrusion process according to the invention, the vacuum unit comprises a strand channel, the surface of which is designed so as to be friction-reducing at least in the regions in which there is contact between the strand and the surface of the strand channel.

A friction-reducing design can also be achieved by coating the surface for example with PTFE (polytetrafluorethylene) or by means of treating the surface in another manner, for example by means of forming a surface that is hemispherical on a microscopic scale. The friction-reducing design of the surface can advantageously reduce the fibre damage owing to friction in the strand channel, and wear of the surface of the strand channel.

In a further preferred embodiment of the pultrusion process according to the invention, the vacuum unit comprises at least two chambers that are interconnected in an airtight manner. Said chambers are particularly preferably vacuum chambers, very particularly preferably vacuum chambers in which different absolute pressure values, constituting negative relative pressure values, can be set, for example by means of vacuum pumps of different types being connected to the connections having access to the relevant vacuum chambers. Very particularly preferably, each of the vacuum chambers of a vacuum unit may comprise a connection for mutually different vacuum pumps. It is also possible, however, to use one vacuum pump for two or more vacuum chambers simultaneously.

The term chambers also includes chambers of the type also referred to as “inactive chambers” which are at least not continuously connected to a vacuum pump. If an inactive chamber is arranged between two vacuum chambers for example, said inactive chamber functions, in a manner similar to the case of a labyrinth seal, as an extension of the flow path between the vacuum chambers, such that it is advantageously possible to achieve a lower absolute pressure in the vacuum chamber that is to the rear in the pultrusion direction.

Owing to the airtight connection, undesired airflows in the chambers and between the at least two chambers are suppressed or at least limited to a level that does not impair the process.

In order to achieve sealing of the vacuum unit from the surroundings and sealing between the chambers of the vacuum unit, it is necessary for a strand having suitable dimensions to be arranged in the vacuum unit. If no strand is arranged in the vacuum unit, the vacuum unit is open to the surroundings thereof via the strand channel provided for the strand.

At least the sealing element of the vacuum unit that is first in the pultrusion direction is used for sealing the vacuum unit with respect to the surroundings thereof. Ambient air pressure prevails on the downstream face of said sealing element, and the absolute pressure established in the vacuum chamber of the vacuum unit that is first in the pultrusion direction, which absolute pressure is lower than the ambient air pressure, prevails on the vacuum face of said sealing element. The pressure difference applied to the first sealing element corresponds to the relative pressure in the first vacuum chamber. The pressure difference between the two faces of the sealing elements arranged between the chambers of the vacuum unit is generally lower.

In this case, the term “sealing element” includes all elements by means of which undesired flows, in particular air flows, in the reservoir to be sealed by the sealing element are at least limited to a level that does not impair the process.

An absolute pressure value of less than or equal to 300 mbar, particularly preferably an absolute pressure value of less than or equal to 150 mbar, very particularly preferably an absolute pressure value of less than or equal to 50 mbar, is preferably generated in the final vacuum chamber of the vacuum unit in the pultrusion direction.

An embodiment of the vacuum unit comprising a plurality of chambers advantageously makes it possible for a pressure gradient to form between the chambers, it being possible to achieve a particularly low absolute pressure at least in the final vacuum chamber in the pultrusion direction.

In a further preferred embodiment of the pultrusion process according to the invention, the vacuum unit comprises at least one annular element that is arranged in a stationary manner around the strand of unsaturated fibres and functions as a sealing element of the vacuum unit. The vacuum unit particularly preferably comprises a plurality of annular elements that are arranged in a stationary manner around the strand of unsaturated fibres, which elements are interconnected so as to be airtight with respect to one another and with respect to the surroundings.

A stationary annular element comprises at least one stationary region, i.e. a region that is not moved together with the strand of unsaturated fibres, in which region the strand of unsaturated fibres fits fully. Said region will also be referred to in the following as the “contact region”, even if the fit can be characterised as a clearance fit. Said at least one region of a stationary annular element constitutes a sealing surface, a “sealing surface” referring to the surface of a sealing element at which the sealing effect is achieved. In this case, the characteristic dimensions of the surface surrounded by the sealing surface of at least one stationary annular element are selected so as to be smaller than or equal to the corresponding characteristic dimensions of the strand of unsaturated fibres. In the case of a strand of unsaturated fibres having a circular cross section, the characteristic dimensions correspond to the diameter of the cross section or the diameter of the surface surrounded by the sealing surface of a stationary annular element. In the case of a strand of unsaturated fibres having a square cross section, the characteristic dimensions correspond to the diagonals and side lengths of the cross section or the diagonals and side lengths of the surface surrounded by the sealing surface of a stationary annular element.

In the embodiment described, comprising stationary annular elements, the vacuum unit can be formed as an integral, i.e. one-piece, component. The integral construction advantageously does not have any joints, with the result that fibre damage resulting from increased friction at the joints is prevented.

The vacuum unit in the embodiment described may likewise be formed as a modular component, a module comprising at least one chamber for example. The modules are interconnected so as to be airtight at least with respect to the surroundings, for example by means of flanges comprising elastomer seals and bracing elements. The number of modules, and thus of the chambers, can advantageously be adjusted for example to the process conditions and the desired absolute pressure in the final vacuum chamber. The modular construction furthermore advantageously does not have any axial joints, i.e. joints in parallel with the pultrusion direction. As a result, fibre damage resulting from jamming, in particular in the case of unidirectional fibres, as well as increased friction between the strand and the joints, can be prevented.

If the vacuum unit consists of a plurality of chambers, the following embodiments a) to c) for the stationary annular elements of the vacuum unit are particularly preferred:

Embodiment a): the characteristic dimensions of the surface surrounded by the sealing surface of a stationary annular element are smaller, relative to one another, in the pultrusion direction, the characteristic dimensions of the surface surrounded by the sealing surface of the final stationary annular element in the pultrusion direction being smaller than the characteristic dimensions of the strand of unsaturated fibres, in order to achieve a strong sealing effect. The dimensions of the surfaces surrounded by the sealing surfaces of the stationary annular elements that are arranged upstream of the final stationary annular element in the pultrusion direction are greater than or equal to the characteristic dimensions of the strand of unsaturated fibres. An advantage in the case of this embodiment is the low mechanical friction between the sealing surfaces of the stationary annular elements arranged upstream of the final stationary annular element, and the strand of unsaturated fibres.

Embodiment b): at least taking account of manufacturing-related fluctuations or size tolerances, the characteristic dimensions of the surfaces surrounded by the sealing surfaces of all the stationary annular elements of the vacuum unit are the same and correspond to the characteristic dimensions of the strand of unsaturated fibres. In the case of this embodiment, a strong sealing effect is advantageously achieved at the sealing surfaces of all the stationary annular elements. There is, however, significant mechanical friction between the sealing surfaces of the stationary annular elements and the strand of unsaturated fibres.

Embodiment c): the characteristic dimensions of the surfaces surrounded by the sealing surfaces of all the stationary annular elements of the vacuum unit are smaller than the characteristic dimensions of the strand of unsaturated fibres. An advantage of this embodiment is the particularly strong sealing effect at the sealing surfaces of all the stationary annular seals, such that in particular the absolute pressure that can be achieved in the final chamber of the vacuum unit is particularly small. The mechanical friction between the sealing surfaces of the stationary annular seals and the strand of unsaturated fibres is high in this embodiment.

Embodiment a) is very particularly preferred.

In an alternative preferred embodiment of the pultrusion process according to the invention, the vacuum unit comprises rotating roller sealing elements. In this embodiment, the sealing elements that comprising a sealing surface facing the strand of unsaturated fibres are not stationary but instead consist of rollers that are rotatably mounted on a shaft in each case, the rollers being of a rotationally symmetrical, preferably cotton reel-type, shape. Two rotating roller seal elements in each case are arranged relative to one another in the manner of half shells, and surround the strand of unsaturated fibres. The rotating roller seal elements are set into rotation by the directed movement of the strand of unsaturated fibres, owing to rolling friction.

In this embodiment, sealing surfaces exist not only between one rotating roller seal element and the strand of unsaturated fibres in each case, but instead also between two rotating roller seal elements in each case, which elements roll against one another in opposing directions of rotation, and between a rotating roller seal element and sealing elements arranged in a stationary manner in an airtight housing of the vacuum unit in each case, which sealing elements are suitable for sealing a rotating roller seal element with respect to the airtight housing of the vacuum unit.

In order to increase the sealing effect, at least the sealing surfaces of the rotating roller seal elements may be assigned sealing means rigidly arranged on the rotating roller seal elements at least in part, for example elastomers. In order to reduce the friction resulting at the sealing surfaces in particular against the stationary sealing elements of the housing of the vacuum unit, at least the sealing surfaces of the rotating roller seal elements may be assigned sealing means rigidly arranged on the rotating roller seal elements at least in part, which sealing means have a friction-reducing effect, for example vacuum grease.

There is advantageously substantially no static friction, but instead rolling friction, between the strand of unsaturated fibres that is moved through the vacuum unit and the sealing surfaces of the rotating roller seal elements that provides the sealing with respect to the strand of unsaturated fibres, with the result that the likelihood of undesired fibre displacements and/or fibre damage owing to the adhesion of the moving strand to the sealing surfaces is low. Furthermore, the draw-off force to be applied in order to drive the strand in the pultrusion process can be reduced.

In a further alternative preferred embodiment of the pultrusion process according to the invention, the vacuum unit comprises at least two arrangements of rotating roller seal elements, at least two rotating roller seal elements arranged in succession in the pultrusion direction being interconnected, in one arrangement, in the manner of a conveyor belt, by means of a sealing strip. A conveyor belt-like arrangement can in addition also comprise a drive and/or clamping element for the sealing strip.

The rotating roller seal elements that are rotatably mounted on a shaft are rotationally symmetrical and preferably formed in the manner of a cotton reel. Two rotating roller seal elements in each case are arranged relative to one another in the manner of half shells, and surround the strand of unsaturated fibres. The sealing strip is a planar strip having a closed periphery, which strip particularly preferably consists of an elastomer. The width of the sealing strip, i.e. the dimension of the sealing strip in parallel with the shaft of the rotating roller seal elements, corresponds to approximately half the periphery of the strand of unsaturated fibres plus twice the length of the region in which the roller seal elements that are arranged relative to one another in the manner of half shells are in contact with one another at least indirectly via the sealing strip.

If the conveyor belt-like arrangement comprises a drive element, said element sets the sealing strip in the conveyor belt-like arrangement into movement in the pultrusion direction. The sealing strip may for example also be set into movement in the pultrusion direction by means of the movement of the strand in the strand channel, and therefore a separate drive element is not necessary. The roller seal elements arranged in the manner of half shells roll against one another in opposing directions of rotation, the sealing strip being arranged on the sealing surface between each of the rotating roller seal elements and the other rotating roller seal element, formed in the manner of a half shell. The mutually facing sealing surface of the rotating roller seal element is thus between the two sealing strips of the at least two conveyor belt-like arrangements. Furthermore, the sealing strip is also arranged on the sealing surface between the rotating roller seal elements and the strand of unsaturated fibres.

The region between two rotating roller seal elements, arranged in succession in the pultrusion direction, of a conveyor belt-like arrangement corresponds to a chamber of the vacuum unit. The number of chambers of the vacuum unit can be increased by increasing the number of rotating roller seal elements in a conveyor belt-like arrangement. Air can escape from the strand of unsaturated fibres in a chamber of the vacuum unit, since the sealing strip is in contact with the strand of unsaturated fibres in a non-airtight manner in the region between two rotating roller seal elements of a conveyor belt-like arrangement, arranged in succession in the pultrusion direction.

Each rotating roller seal element in the conveyor belt-like arrangement furthermore rolls on a counter roller element, such that a sealing surface results between the sealing strip arranged on the rotating roller seal element and the counter roller element. The counter roller element rolls in a sealing manner on a sealing element that is arranged in a stationary manner on the airtight housing of the vacuum unit.

In order to reduce the friction resulting at the sealing surfaces in particular against the stationary sealing elements of the housing of the vacuum unit, at least the sealing surfaces of the rotating roller seal elements and of the counter roller elements associated with the sealing elements arranged in a stationary manner in the vacuum unit may be assigned sealing means rigidly arranged on the rotating roller seal elements and on the counter roller elements at least in part, which sealing means have a friction-reducing effect, for example vacuum grease.

Advantageously, in the case of the described embodiment, the likelihood of undesired fibre displacement owing to adhesion of the moving strand on the sealing surfaces, and the likelihood of fibre damage, is low. Furthermore, the draw-off force to be applied in order to drive the strand in the pultrusion process can be reduced. The described embodiment makes it possible for a particularly strong sealing effect to be achieved.

The vacuum unit and the injection unit are interconnected so as to be airtight with respect to the surroundings in such a way that, when the strand of unsaturated fibres is removed from the vacuum unit and fed to the injection unit, the penetration of ambient air into the strand of unsaturated fibres can be prevented or at least limited to a level that does not impair the process. The connection can be achieved for example by means of a flange comprising an O-ring seal consisting of an elastomer.

Various embodiments of the pultrusion process according to the invention will be described in the following, which embodiments relate to the process steps in the injection unit.

Matrix material is injected into the at least one injection chamber of the injection unit via at least one injection channel that is connected to a reservoir in which matrix material is contained. The injection can take place at a positive relative pressure or without relative pressure, injection at a positive relative pressure being preferred. The positive relative pressure is preferably at least 0.5 bar, in order to achieve directed flow of the matrix material, particularly preferably at least 5 bar, very particularly preferably at least 50 bar. The relative pressure at which the matrix material is injected is referred to as the “injection pressure”.

The at least one injection chamber preferably comprises at least one region in which the strand fits completely, for example in that the dimensions of said chamber perpendicularly to the pultrusion direction correspond to the corresponding dimensions of the strand perpendicularly to the pultrusion direction. In other words, the at least one injection chamber preferably comprises at least one region of contact with the strand. The dimensions of the at least one injection chamber perpendicularly to the pultrusion direction preferably increase, in the pultrusion direction, downstream of a contact region, and reduce again towards a second contact region. A contact region performs a throttle function with respect to the injection pressure. The at least one injection channel is preferably arranged in the region in which the dimensions of the injection chamber perpendicularly to the pultrusion direction are greatest.

Preferably, furthermore, a contact region may exist in the injection unit, between the sealing elements formed as sealing lips and the strand.

In a further preferred embodiment of the pultrusion process according to the invention, the injection unit comprises at least two chambers that are in succession in the pultrusion direction. In this case, the term chambers also includes chambers of the type referred to as “inactive chambers”, into which matrix material is not, or at least not continuously, injected. The injection unit particularly preferably comprises at least two injection chambers which each comprise an injection channel and are connected to a reservoir for matrix material. The at least two injection chambers are designed such that matrix material can be injected into the at least two injection chambers at mutually different positive relative pressure values. In particular, the relative pressure values are selected such that the highest relative pressure is present in the injection chamber that is furthest from the vacuum unit, and the lowest relative pressure is present in the injection chamber that is closest to the vacuum unit. The lowest relative pressure should be selected such that penetration of matrix material into the vacuum unit owing to the pressure difference between the injection chamber having the lowest relative pressure and the vacuum unit is at least largely prevented. The highest relative pressure should be selected such that homogeneous and full impregnation of the fibres of the strand is achieved and for example capillary effects, which impede wetting of the fibres, are overcome.

In a further preferred embodiment of the pultrusion process according to the invention, the injection unit comprises at least one drainage chamber upstream of and/or downstream of the at least one injection chamber and/or between two chambers in the pultrusion direction, which drainage chamber comprises an entrance to a drainage gully by means of which excess matrix material can be discharged from the injection unit.

In a further preferred embodiment of the pultrusion process according to the invention, the injection unit is formed as an integral, i.e. one-piece, component. The injection apparatus thus advantageously does not comprise any joints, in particular no axial joints, i.e. joints in parallel with the pultrusion direction, which could result in damage to the fibres of the strand when passing through the injection unit. Fibre damage results for example from jamming, in particular in the case of unidirectional fibres, as well as high friction on axial joints.

In an alternative preferred embodiment of the pultrusion process according to the invention, the injection unit is in a modular construction which is characterised in that a plurality of mutually separable chamber modules are arranged in succession in the pultrusion direction. Particularly preferably, at least one drainage chamber module may be arranged upstream of and/or downstream of and/or between the chamber modules. In this case, the chamber modules of the injection unit may also comprise inactive chamber modules that are not designed as injection or drainage chamber modules and into which matrix material is not, or is at least not continuously, injected. The chamber modules of the injection unit are interconnected so as to be airtight at least with respect to the surroundings. The modular embodiment of the injection unit also advantageously does not comprise any axial joints. A further advantage of the modular embodiment is that the number of the chambers, in particular the injection chambers, of the injection unit can be varied and selected so as to be matched to the process. Furthermore, sealing elements comprising sealing surfaces facing the strand may be arranged on the chamber modules, by means of which elements a strong sealing effect can be achieved, for example sealing lips.

In a further preferred embodiment of the pultrusion process according to the invention, the injection unit comprises a strand channel, the surface of the strand channel being provided with a wear protection layer at least in the regions of contact with the strand. The wear protection layer is particularly preferably complete and break-free. In this case, “break-free” also includes the case that the entire surface of the at least one injection chamber, as well as the optional further chambers thereof, if provided, is equipped with the wear protection layer. A single or multiple layer consisting of one or more metals or metal alloys can particularly preferably be used as the wear protection layer, very particularly preferably a hard chrome layer (chromium(VI)), a tungsten carbide layer, a chromium carbide layer or a chromium(III) layer. Furthermore, ceramic layers can particularly preferably be used.

In a further preferred embodiment of the pultrusion process according to the invention, at least one temperature-control element is arranged on the injection unit. In this case, the at least one temperature-control element may comprise a heating element, for example a heating cartridge, and/or a cooling element, for example a coolant channel. Temperature control of the injection unit can advantageously influence the temperature-dependent viscosity of the matrix material and improve the impregnation of the strand.

According to a further preferred embodiment of the pultrusion process according to the invention, at least the elements of the vacuum unit and/or of the injection unit which have a region of contact with the strand perform a rotational movement around the strand, the strand being rotationally symmetrical about a strand axis.

The rotational movement around the strand has positive effects on the processability of the strand by means of the vacuum and/or injection unit. Producing the strand in a manner involving a rotational movement can advantageously improve the achievable mechanical properties of the strand.

Each fibre on the strand surface enters the contact region of an element of the vacuum unit and/or of the injection unit at a defined point. The region comprising said defined points is referred to as the entry region of the strand into the contact region.

The described embodiment of the pultrusion process according to the invention causes a rotational movement to be superimposed on the translational movement of the strand in the entry region into the contact region of the elements of the units.

Particularly preferably, the entire vacuum unit and/or the entire injection unit perform the rotational movement around the strand. It is also possible, however, to design the vacuum unit and/or the injection unit such that only portions of the elements thereof or only those elements thereof that comprise a region of contact with the strand perform the rotational movement around the strand, the extension of the portions of the elements in the pultrusion direction at least comprising the entry region of the strand into the contact region.

The described embodiment of the pultrusion process according to the invention is particularly advantageous when the vacuum unit is designed having stationary annular elements. The described embodiment of the pultrusion process according to the invention is furthermore particularly advantageous when the injection unit is designed without sealing lips.

The pultrusion process according to the invention and the embodiments thereof ensures that the strand leaves the injection unit fully impregnated with matrix material. Upon removal from the injection unit, the surface of an FRP blank of this kind is generally formed such that no air from the surroundings penetrates into the inside of the blank. Emerging from the injection unit, the blank can be fed to the cutting unit and cut to length, and the matrix material can be cured without the blank being fed to a coating unit.

Forming a coated surface of the blank is particularly advantageous if said blank is intended to undergo further processing before the matrix material is cured, in particular shaping, non-cutting processing, in which at least regions of the surface are stretched or compressed for example. Following removal from the injection unit, the blank can then be fed to a coating unit.

In a preferred embodiment of the pultrusion process according to the invention, the injection unit and the coating unit are interconnected so as to be airtight at least with respect to the surroundings. This can advantageously ensure that, following removal from the injection unit and upon feeding into the coating unit, air cannot penetrate into the FRP blank, or at least can penetrate therein only to an extent limited to a level that does not impair the process.

Various embodiments for forming a coated surface of the FRP blank produced by means of the pultrusion process according to the invention using intrinsic or extrinsic elements will be described in the following.

In a preferred embodiment, a coated surface is formed by means of partial consolidation of the matrix material on the surface of the blank. The partial consolidation can be achieved for example by means of a tool comprising a heating cartridge, which tool may directly follow the injection unit. In this embodiment, the blank is preferably cut to length after the partially consolidated surface has been formed.

In an alternative preferred embodiment, a coated surface is formed by means of cooling the matrix material on the surface of the blank, at a high cooling rate, to below the glass transition temperature thereof, which temperature is dependent on the process conditions. The cooling can take place for example by means of a cryogenic cooling chamber or a cryogenic belt cooler arranged downstream of the injection unit. The blank is generally cut to length after cooling.

Forming a coated surface by means of the described intrinsic elements is advantageous in that no additional coating materials need to be applied. The cross-sectional area of the blank is advantageously not increased, and therefore no additional installation space needs to be provided.

The intrinsically coated surface can for example also be advantageously formed in evacuated vacuum continuous flow facilities, in particular if the injection unit and coating unit are interconnected so as to be airtight at least with respect to the surroundings.

According to further preferred embodiments, extrinsic elements are provided on the arrangement in order to form a coated surface.

According to a preferred embodiment for forming a coated surface, the blank passes through a sprinkling unit, the surface of the blank being sprinkled or sprayed with a material, for example a plastics material, the material forming an airtight coating when cured. The sprinkling unit may for example be an arrangement for forming a curtain of fluid plastics material (frequently also referred to as “curtain coating”), or may be a nozzle arrangement. In this embodiment, the blank is preferably cut to length after passing through the sprinkling unit.

According to an alternative preferred embodiment for forming a coated surface, the blank passes through an immersion bath filled with material suitable for coating the blank. This material may be a heated, liquified wax for example, which hardens by means of free cooling after leaving the immersion bath and forms an airtight coating. In this embodiment, the blank is preferably cut to length after passing through the immersion bath.

In particular if the injection unit and coating unit are intended to be interconnected so as to be airtight at least with respect to the surroundings, a coated surface can also be formed by means of an immersion bath such that the entry of the FRP blank into the trough is sealed and can take place from below, following deflection of the FRP blank for example.

In a further alternative preferred embodiment, an extruder according to the prior art is used for forming a coated surface of the blank. Thermoplastics or thermoplastic elastomers in granulate form are processed in the extruder. High-melting thermoplastics, for example PA6 (PA=polyamide) or PA12 can bring about permanent coating which remains on the blank following further processing. A temporary, substantially removable coating can be achieved by means of low-melting thermoplastics, for example PE (PE=polyethylene) or special waxes based on polyolefins, in particular PP-based (PP=polypropylene). A particularly flexible coating for subsequent shaping operations can be achieved using thermoplastic elastomers, for example TPU (TPU=thermoplastic polyurethane). A temporary coating can be removed following further processing, for example by being melted off. In this embodiment, the blank is preferably cut to length after the coating has been formed by means of the extruder. A particular advantage of the described embodiment is that a coating is achieved having a well-defined thickness that is adjustable in a wide range. Furthermore, when producing blanks in the form of hollow profiles, the mould core and the coating can be manufactured from the same material and removed in a common process step.

The coating can for example also be extruded by means of a vacuum-assisted tool, in particular if the injection unit and coating unit are intended to be interconnected so as to be airtight at least with respect to the surroundings. This advantageously results in an application of the coating onto the surface of the FRP blank that is particularly free of air bubbles.

Further alternative preferred embodiments for forming a coated surface relate to the arrangement of a film, for example consisting of PE or an elastomer, e.g. silicone, on the surface of the blank.

One of said preferred embodiments relates to wrapping a film around the blank by means of a mounting for at least one film roll that rotates around the blank, the shaft of the film roll being in parallel with the pultrusion direction and rigidly arranged on the rotating mounting. In this embodiment, the blank is preferably cut to length after the wrapping process. This embodiment particularly advantageously allows for flexible adjustment of the coating thickness, for example by means of the number of film rolls used. Furthermore, this embodiment can be used for a wide range of peripheries and shapes of the cross section of a blank without it being necessary to adjust the mounting.

A further one of said preferred embodiments relates to encasing the blank by means of at least one rigidly arranged film roll, the shaft of which is oriented so as to be perpendicular to the pultrusion direction. For this purpose it is necessary to throw the film around the blank, and this is preferably achieved by means of an apparatus that tapers in a funnel shape in the pultrusion direction, to the dimensions of the blank perpendicularly to the pultrusion direction, and that comprises at least one opening that extends in the pultrusion direction. The film is arranged in said apparatus and is applied to the blank in the region of the taper. The film regions are connected in the region of the at least one opening, for example by means of welding or adhesive bonding. In this embodiment, the blank is preferably cut to length after the encasing process.

Yet a further one of said preferred embodiments relates to rolling up the blank, which is preferably carried out after cutting to length. In this case, a film roll is arranged on a rotating shaft, the shaft being oriented in parallel with the shaft of the blank that has been cut to length. The film is drawn into a region comprising rotating rollers, and the blank is also laid on the film in said region. The film is drawn in and the rotation of the blank required for rolling up said blank in the film is achieved by means of rotation of the rollers. The film overlaps slightly at the joins. If the blank is fully coated, the film is detached. The embodiment can advantageously be adjusted in a simple manner to varying peripheries and shapes of the cross sections of a blank.

The invention also relates to an arrangement for carrying out a pultrusion process for continuous production of blanks from fibre-reinforced plastics composite material, comprising a vacuum unit that comprises at least one vacuum chamber, the vacuum unit comprising at least one connection for a vacuum pump, and the vacuum unit being designed such that a negative relative pressure can be generated in the at least one vacuum chamber thereof, as a result of which pressure air escapes from a strand of unsaturated fibres, said arrangement further comprising an injection unit comprising at least one injection chamber into which matrix material can be injected, in a fluid state, which injection chamber is designed for impregnating the strand with the matrix material, the vacuum unit being arranged upstream of the injection unit in the pultrusion direction.

In a preferred embodiment of the arrangement according to the invention, the arrangement comprises elements which are designed to set the vacuum unit and/or the injection unit or at least the elements of the vacuum unit and/or of the injection unit which have a region of contact with the strand, into a rotational movement around the strand.

This embodiment is suitable for a strand that is rotationally symmetrical about a strand axis.

In this case, the rotational movement is to be performed as described above in connection with the process according to the invention.

In a further preferred embodiment of the arrangement according to the invention, said arrangement additionally comprises a coating unit which is arranged downstream of the injection unit in the pultrusion direction.

In another preferred embodiment of the arrangement according to the invention, said arrangement additionally contains a cutting unit, which is arranged either downstream of the injection unit or downstream of the coating unit, in each case in the pultrusion direction.

In the arrangement, the individual components (in particular the vacuum unit, the injection unit and optionally the coating unit and/or the cutting unit) are designed as described above with reference to the pultrusion process according to the invention.

The arrangement is particularly preferably suitable for carrying out the pultrusion process according to the invention.

The invention also relates to the use of the pultrusion process according to the invention or of the arrangement according to the invention for producing blanks from a fibre-reinforced plastics composite material as solid blanks, i.e. in the form of solid profiles.

Furthermore, the pultrusion process according to the invention and the arrangement according to the invention are also suitable for producing blanks from a fibre-reinforced plastics composite material as hollow profiles. For this purpose, a rigid or a flexible mould core is preferably arranged in the strand.

In order to produce blanks in the form of hollow profiles, a rigid or flexible mould core consisting of solid material may be arranged in the strand, around which core the fibres or semi-finished fibre products are bundled. Likewise, a rigid or flexible tube may be arranged in the strand as a mould core, around which the fibres or semi-finished fibre products are bundled. A rigid mould core consisting of solid material can advantageously be removed, for example by means of pressing out, following curing of the matrix material, no tools being required for the curing. A rigid tube as a mould core can advantageously be removed by being drilled out for example. A flexible mould core consisting of solid material, or a flexible tube as the mould core, is advantageously used if the blank is intended to undergo a shaping process, and said core can be removed following shaping, for example by being melted out. Furthermore, both a rigid and a flexible mould core consisting of solid material, or a rigid or flexible tube as the mould core, can remain in the component following curing of the matrix material.

### Embodiments

The pultrusion process according to the invention will be explained in greater detail in the following, with reference to drawings, but without being limited to said embodiments.

### BRIEF DESCRIPTION OF THE DRAWINGS

In the drawings:

FIG. 1 is a schematic view of a pultrusion facility which comprises an embodiment of an arrangement according to the invention and is suitable for carrying out the process according to the invention;

FIG. 2a shows an embodiment of an arrangement according to the invention;

FIG. 2b shows a further embodiment of an arrangement according to the invention which comprises a coating unit;

FIG. 3a is a longitudinal section of an embodiment of a vacuum unit comprising a plurality of vacuum chambers in a modular construction, the cutting plane corresponding to the centre plane of the strand and being in parallel with the pultrusion direction, and the vacuum unit comprising stationary annular elements;

FIG. 3b shows an embodiment of a modular vacuum unit comprising a plurality of vacuum chambers and stationary annular elements, as in FIG. 3a, the vacuum unit comprising elements for performing a rotation about the strand axis;

FIG. 3c shows an embodiment of an integral vacuum unit comprising a plurality of vacuum chambers and stationary annular elements, shown as in FIG. 3a, the vacuum unit comprising elements for performing a rotation about the strand axis;

FIG. 4a is the side view of an alternative embodiment of a vacuum unit comprising a plurality of vacuum chambers, the vacuum unit comprising rotating rollers as sealing elements;

FIG. 4b shows the cross sectional view shown in FIG. 4a, along the line A-A perpendicularly to the pultrusion direction of the embodiment of a vacuum unit shown in FIG. 4a;

FIG. 5a is the side view of a further alternative embodiment of a vacuum unit comprising a plurality of vacuum chambers, the vacuum unit comprising two conveyor belt-like arrangements having rotating rollers that are connected by means of a sealing strip;

FIG. 5b shows the cross sectional view shown in FIG. 5a, along the line A-A perpendicularly to the pultrusion direction of the embodiment of a vacuum unit shown in FIG. 5a;

FIG. 6a is a longitudinal section of an embodiment of an injection unit in an integral construction, the cutting plane corresponding to the centre plane of the strand and being in parallel with the pultrusion direction;

FIG. 6b shows an embodiment of an integral injection unit, as in FIG. 6a, the injection unit comprising elements for performing a rotation about the strand axis;

FIG. 7 is a longitudinal section of an alternative embodiment of an injection unit in a modular construction, the cutting plane corresponding to the centre plane of the strand and being in parallel with the pultrusion direction;

FIG. 8a is a plan view of an embodiment of a coating unit, the FRP blank being coated in a film by means of rolling up.

FIG. 8b shows the cross sectional view of the coating unit shown in FIG. 8a, along the line A-A.

### DETAILED DESCRIPTION OF THE PREFERRED EMBODIMENTS

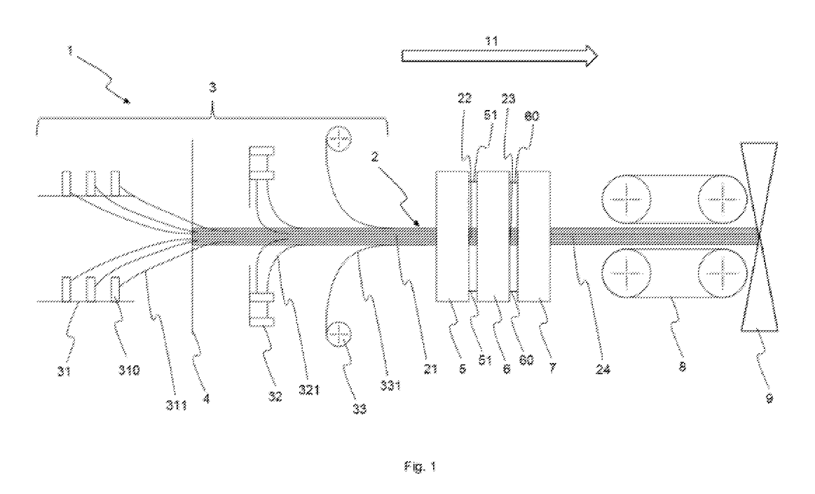

FIG. 1 is a schematic view of a pultrusion facility 1 which is suitable for continuously producing an FRP blank 23 in accordance with the pultrusion process according to the invention. The FRP blank may have a round, oval or polygonal, e.g. T-shaped, cross section. The strand 2 that passes through the pultrusion facility 1 comprises bundled fibres or semi-finished fibre products which are arranged in a supply region 3. The supply region 3 comprises, by way of example, a creel 31 comprising a plurality of spools 310 from which continuous fibres or rovings 311 are drawn off in the pultrusion direction 11 and bundled in a guide unit 4. The supply region 3 further comprises, by way of example, a winding wheel 32 by means of which for example rovings 321 can be laid on the strand 2 at an adjustable angle relative to the pultrusion direction, and a number of fibre strip spools 33 from which for example fibre strips 331, mats or unbonded webs are laid on the strand 2 for the purpose of reinforcement.

The strand of unsaturated fibres 21 is drawn into a vacuum unit 5, in the pultrusion direction 11, which vacuum unit said strand leaves as a virtually evacuated strand of unsaturated fibres 22. At least one vacuum pump (not shown) is connected to the vacuum unit 5 in order to generate a negative relative pressure in the vacuum unit 5. The virtually evacuated strand of unsaturated fibres 22 is then drawn into an injection unit 6 in which said strand is impregnated. The vacuum unit 5 and injection unit 6 are interconnected by means of the connecting element 51, for example a flange sealed by an elastomer O-ring, so as to be airtight with respect to the surroundings of the pultrusion facility 1, such that no ambient air penetrates into the virtually evacuated strand of unsaturated fibres 22 during the transition from the vacuum unit 5 into the injection unit 6. The strand leaves the injection unit fully impregnated with matrix material, in the form of an FRP blank 23. The injection unit 6 and a coating unit 7 are interconnected by means of the connecting element 60, which is sealed by an elastomer O-ring for example, so as to be airtight with respect to the surroundings of the pultrusion facility 1, such that it is ensured that no ambient air penetrates into the FRP blank 23 during the transition from the injection unit 6 into the coating unit 7. Since the FRP blank 23 is generally fully impregnated, a pultrusion facility 1 can also be operated without a connecting element 60 between the injection unit 6 and the coating unit 7. Following impregnation, the FRP blank is fed to the coating unit 7 in which a coated surface of the FRP blank 23 is formed, the coated surface also being airtight when stretched, compressed or shaped in another manner. The FRP blank 24 comprising a coated surface then passes through the draw-off unit, by means of which unit the strand 2 is drawn through the pultrusion facility 1. The embodiment shows a strip draw-off unit 8. Following the strip draw-off unit 8, the FRP blank 24 comprising a coated surface is cut to length, to appropriate dimensions, by means of a cutting unit 9, for example a saw, and can be fed to further process steps (not shown).

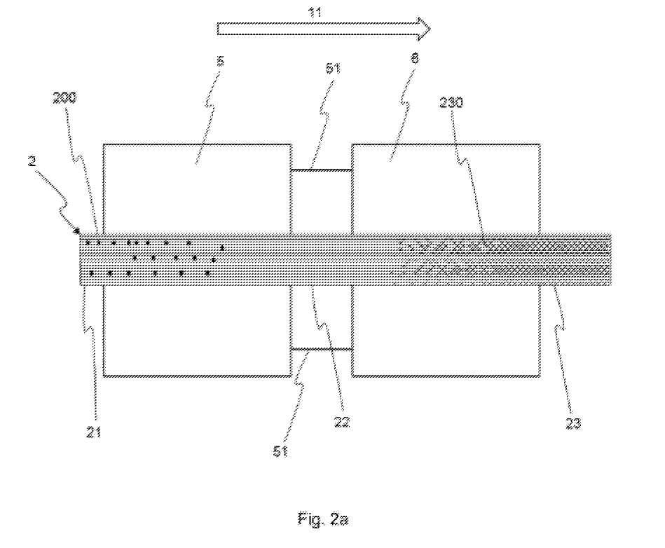

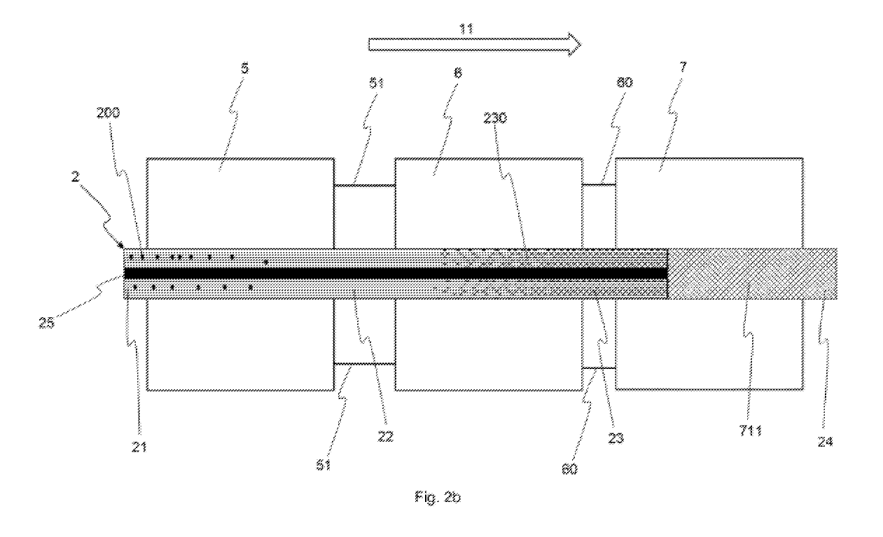

FIG. 2a shows an embodiment of an arrangement according to the invention. The arrangement comprises the portion of a pultrusion facility from the vacuum unit 5 as far as the injection unit 6, the vacuum unit 5 being connected to the injection unit 6, by means of the connecting element 51, so as to be airtight with respect to the surroundings, and being suitable for continuously producing an FRP blank 23 in the form of a solid profile, in accordance with the pultrusion process according to the invention.

A strand of unsaturated fibres 21 is guided into the vacuum unit 5, air bubbles 200 being trapped in the strand of unsaturated fibres 21 upon entry into the vacuum unit 5. The air bubbles 200 escape in the vacuum unit 5 owing to the negative relative pressure that is generated in the vacuum unit 5 by means of a vacuum pump (not shown), such that a virtually evacuated strand of unsaturated fibres 22 leaves the vacuum unit 5 and is drawn into the injection unit 6. The virtually evacuated strand of unsaturated fibres 22 is impregnated with matrix material 230 in the injection unit 6. A fully impregnated FRP blank 23 leaves the injection unit 6.

FIG. 2b shows an alternative embodiment of an arrangement according to the invention. Said figure schematically shows a detail of a pultrusion facility which is suitable for continuously producing an FRP blank 23 in the form of a hollow profile in accordance with an embodiment of the pultrusion process according to the invention, and for providing said blank with a coated surface. The detail comprises the portion of the pultrusion facility from the vacuum unit 5, which is connected to the injection unit 6, by means of the connecting element 51, so as to be airtight with respect to the surroundings, as far as the coating unit 7, which is connected to the injection unit 6, by means of the connecting element 60, so as to be airtight with respect to the surroundings, the airtight connection between the injection unit 6 and the coating unit 7 being optional.

In order to manufacture a FRP blank 23 in the form of a hollow profile, a mould core 25 that may consist of solid material or may be tubular, is arranged in the strand 2. The mould core 25 is removed following possible shaping (not shown) and following curing of the matrix material 230, for example by means of being pressed out, drilled out or melted out, or remains in the component. As shown in FIG. 2b, a strand of unsaturated fibres 21, the fibres being bundled around the mould core 25, is first guided into the vacuum unit 5, air bubbles 200 being trapped in the strand of unsaturated fibres 21 upon entry into the vacuum unit 5. The air bubbles 200 escape in the vacuum unit 5 owing to the negative relative pressure that is generated in the vacuum unit 5 by means of a vacuum pump (not shown), such that a virtually evacuated strand of unsaturated fibres 22 comprising a mould core 25 leaves the vacuum unit 5 and is drawn into the injection unit 6. The virtually evacuated strand of unsaturated fibres 22 is impregnated with matrix material 230 an the injection unit 6. A fully impregnated FRP blank 23, on the surface of which an airtight coating (shown here as a film 711) is arranged in the coating unit 7, leaves the injection unit 6. The FRP blank 24 comprising a coated surface is fed to further process steps (not shown here).

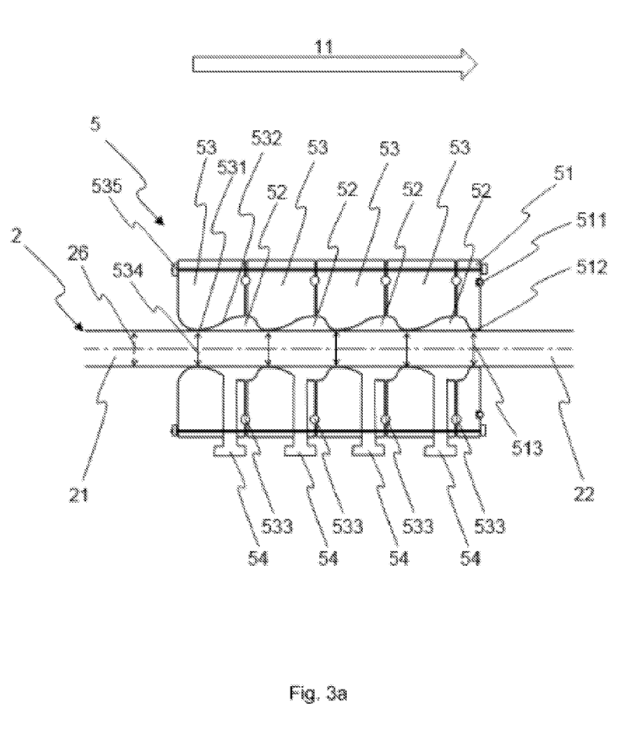

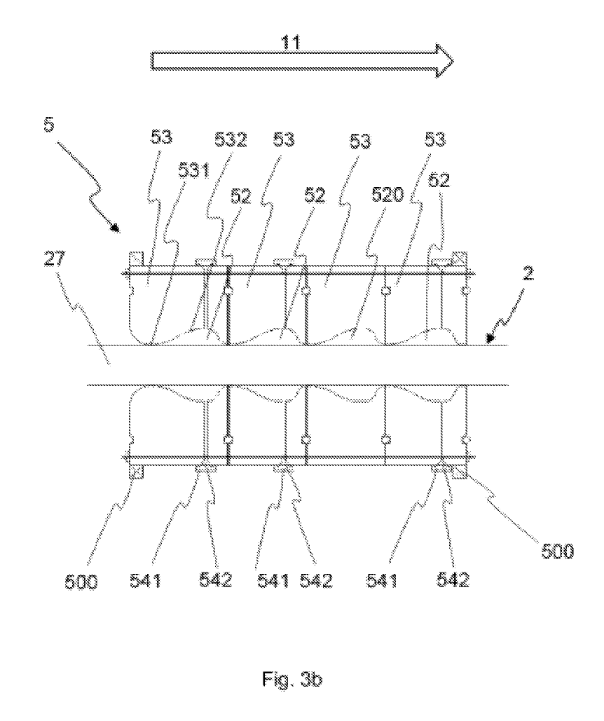

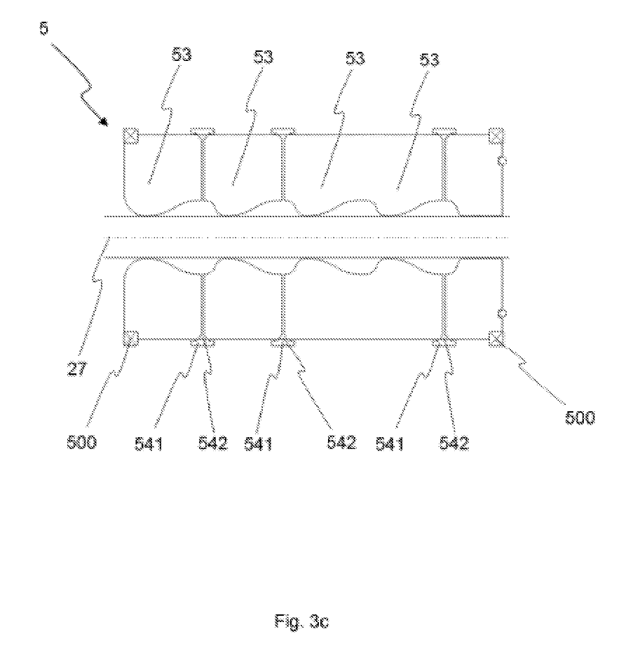

FIG. 3a is a cross section, in the pultrusion direction 11, of an embodiment of a vacuum unit 5 comprising a plurality of vacuum chambers 52 arranged in succession, the vacuum unit 5 comprising a cascade of stationary annular elements 53 that is formed in a modular manner. The components of the vacuum unit 5 are arranged so as to be substantially symmetrical with respect to a longitudinal plane through the centre axis of the strand 2, in the pultrusion direction 11, and therefore, for reasons of clarity, mutually symmetrical components of the vacuum unit 5 are provided with a reference sign just once in each case.

As in all the embodiments of the vacuum unit, the strand 2 enters the vacuum unit 5 as a strand of unsaturated fibres 21, and leaves said unit as a virtually evacuated strand of unsaturated fibres 22. Each stationary annular element 53 comprises a region 531 in which contact takes place between the inner surface 532 thereof (for the sake of improved clarity, the contact region 531 and the inner surface 532 are denoted in FIG. 3a only on the first stationary annular element 53) and the strand 2, such that airtight sealing results between the vacuum chambers 52. The contact region 531 of the first stationary annular element 53 furthermore seals the strand channel of the vacuum unit 5 with respect to the surroundings. The inner surface 532 of a stationary annular element 53 is preferably designed so as to be friction-reducing, since the contact region 531 is subjected to friction with the strand 2 that is moved in the strand channel. The friction-reducing design can for example achieve a lubricating effect between the strand 2 and the inner surface 532, and/or minimise the contact surfaces between the strand 2 and the inner surface 532, as a result of which fibre damage and abrasion of the inner surface 532 are reduced. In order to achieve the friction-reducing design, the inner surface can be formed so as to be hemispherical on a microscopic scale (not shown), for example by means of sandblasting or coating processes. Furthermore, in each case two stationary annular elements 53, arranged in succession, are interconnected by means of an O-ring 533 and a flange or another suitable connection, in this case by means of clamping elements 535 (shown schematically), so as to be airtight with respect to the surroundings. The connecting element 51 sealed by an O-ring 511, which element for example comprises a flange, achieves a connection between the vacuum unit 5 and the following injection unit (not shown) that is airtight with respect to the surroundings. The connecting element 51 also comprises a contact region 512, by means of which the final vacuum chamber 52 is sealed off from the injection unit (not shown) in an airtight manner.

Each vacuum chamber 52 comprises a separate connection 54 for one vacuum pump in each case. It is thus possible to connect vacuum pumps of different types and/or different suction capacities, and to achieve different absolute pressure values in the individual chambers 52, the absolute pressure reducing in the pultrusion direction 11. It is likewise possible for one or more of the chambers shown here as vacuum chambers 52 to be designed as an inactive chamber, in that the connection 54 is closed in an airtight manner, for example by means of a blank flange, after air has been pumped once, and in a manner only to be repeated in specified intervals, into the inactive chamber.

The dimensions 534 of the strand channel in the contact region 531 perpendicularly to the pultrusion direction 11 are selected so as to be smaller, at least at the final two stationary annular elements 53 in the pultrusion direction 11, than the corresponding dimensions 26, i.e. in this case smaller than the diameter, of the strand 2. The sealing of the final vacuum chamber 52 is therefore particularly good, with the result that it is possible to achieve a particularly low absolute pressure value in said vacuum chamber 52. The dimensions 534 of the preceding stationary annular elements 53 are selected so as to be approximately equal to or slightly greater than the corresponding dimensions 26 of the strand, in order to keep the friction between the strand and the inner surface 532 of the stationary annular element lower.

FIG. 3b shows a vacuum unit 5 as a modular cascade of stationary annular elements 53, similar to that in FIG. 3a, drive elements 500 being arranged on the embodiment shown in FIG. 3b in order to perform a rotation of the vacuum unit 5 about the strand axis 27. The strand 2 is designed so as to be rotationally symmetrical about the strand axis 27. The rotation prevents possible accumulation of the fibres on the surface of the strand 2 in the entry region into the respective contact regions 531 of the stationary annular elements 53. Access to the vacuum chambers 52, the boundary 532 of which rotates, is provided, for the process of pumping out using a stationary vacuum pump (not shown) is provided by means of rotary unions 541 that are arranged on a peripheral groove 542.

In FIG. 3b, an inactive chamber 520 is arranged between two vacuum chambers 52, which inactive chamber does not have any access to a vacuum pump. The inactive chamber 520 functions in the manner of a labyrinth seal by lengthening the flow path, such that a lower absolute pressure can advantageously be achieved in the vacuum chamber 52 that is to the rear in the pultrusion direction 11.

FIG. 3c shows an embodiment of a vacuum unit 5 as a cascade of stationary annular elements 53, similar to the drawings in FIG. 3a and FIG. 3b. The vacuum unit 5 is not modular, but instead integral. Said unit can be manufactured for example by means of hollow turning or erosion of solid material, such that advantageously no, in particular no axial, joints are arranged in the strand channel, which joints could lead to fibre damage.

Similarly to the embodiment of FIG. 3b, the vacuum unit 5 shown comprises elements 500, 541, 542 by means of which the vacuum unit 5 can rotate about the strand axis 27.

Owing to the friction in the entry region into the contact region, the rotational movement is transmitted to the fibres on the surface of the strand in part. The translational movement and the rotational movement result in a force on the fibres on the surface of the strand. Said resulting force causes a slight displacement of the fibres on the surface of the strand, which displacement promotes constriction of the strand and thus reduces the diameter of the strand, as a result of which the fibres are subjected to additional tensile stress.

The constriction-promoting effect of the resulting force on a fibre on the strand surface is present apart from in the case in which the direction of the resulting force corresponds to the fibre direction vector in the relevant associated defined point of the entry region into the contact region. In this case the fibre direction vector corresponds to the unit vector, the direction of which reflects the orientation of the fibres on the strand surface. The rotational speed should therefore preferably be selected such that the situation described above does not arise, at least in the case of most of the defined points. Particularly preferably, the rotational speed should be selected such that the situation described above does not arise in the case of more than 80% of the defined points. Said rotational speed or said rotational speeds should be excluded from the range available for the selection of the rotational speed, which range comprises all speeds which cause a resulting force to occur on the fibres on the strand surface.

In this case, the reduction in the diameter of the strand owing to the resulting force is very small compared with the diameter of the strand. After leaving the contact region, the displacement of the fibres is almost completely reversed again by restoring forces owing to the tensile stress. The rotational movement thus at least does not change target geometry of the strand to an inadmissible extent.

The described embodiment is advantageous in that an accumulation of fibres on the surface of the strand, in the entry region into the elements of the vacuum unit and/or of the injection unit which comprise a region of contact with the strand, is at least significantly reduced.

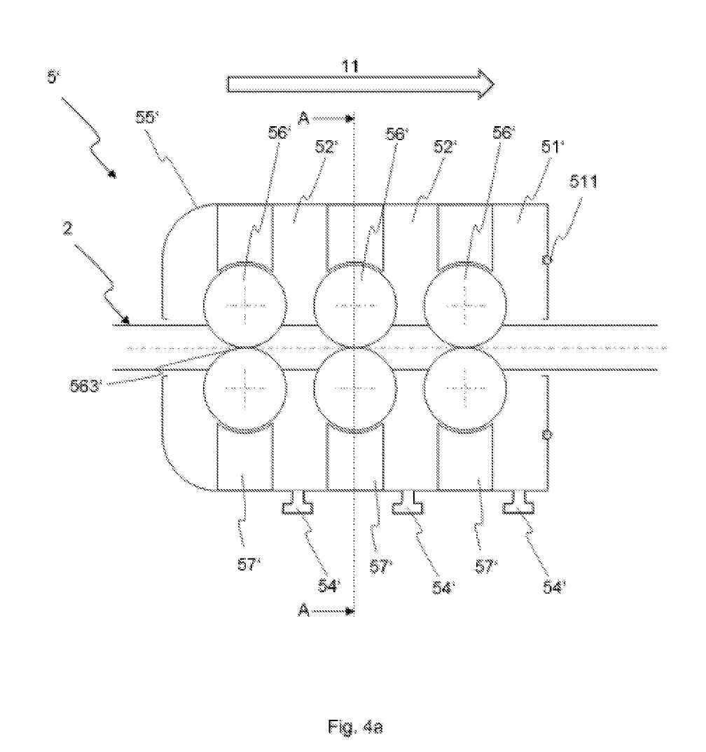

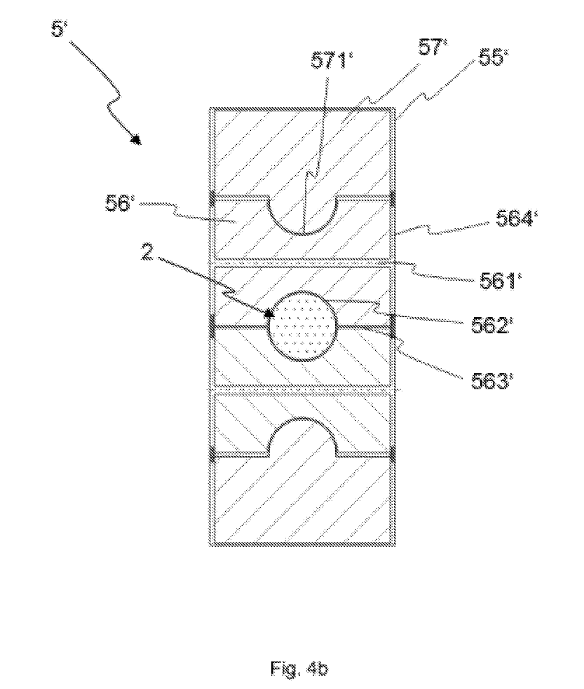

FIGS. 4a and 4b show an alternative embodiment for a vacuum unit 5′ comprising a plurality of vacuum chambers 52′ that are arranged in succession and are located in an airtight housing 55′ comprising a plurality of connection elements, e.g. small flanges, for vacuum pumps 54′. FIG. 4a is a side view of the vacuum unit 5′ shown in the pultrusion direction 11, the side wall of the housing 55′ being removed, and FIG. 4b is a cross section through the vacuum unit 5′ perpendicularly to the pultrusion direction 11, or the plan view of a section through the vacuum unit 5′ along the line A-A shown in FIG. 4a. The components of the vacuum unit 5′ are arranged so as to be substantially symmetrical with respect to a longitudinal plane through the centre axis of the strand 2, in the pultrusion direction 11, and therefore, for reasons of clarity, mutually symmetrical components of the vacuum unit 5′ are provided with a reference sign just once in each case.

In order to seal the vacuum chambers 52′ in an airtight manner with respect to one another and to seal the first vacuum chamber 52′ in an airtight manner with respect to the surroundings of the vacuum unit 5′, the vacuum unit 5′ comprises rollers 56′ that are rotatably mounted on respective shafts 561′ sealed off from the housing 55′ and are in the shape of cotton reels. As can be seen in the plan view of the contact region 562′ shown in FIG. 4b, the contact region 562′ between a roller 56′ and the strand 2 surrounds the relevant surface of the strand 2 in the manner of a half shell. The contact region 562′ forms the sealing surface between the roller 56′ and the strand 2. Each of the rollers 56′ rotates about the shaft 561′ thereof owing to rolling friction in the contact region 562′ resulting from the uniform movement of the strand 2 in the pultrusion direction 11. Owing to the opposing directions of rotation thereof, two rollers 56′ roll against one another in the contact region 563′ between said two rollers 56′, the contact region 563′ forming the sealing surface between the two rollers 56′.

Stationary sealing elements 57′ are arranged on the housing 55′ of the vacuum unit 5′ in a rigid and airtight manner. A stationary sealing element 57′ comprises a region 571′ of contact with one roller 56′ in each case, the roller 56′ rolling against the stationary sealing element 57′ in the contact region 571′. The sealing of a roller 56′ with respect to the housing 55′ is achieved in the contact region 564′ between the roller 56′ and the housing 55′, the surfaces of the roller 56′ and housing 55′ being ground and polished in the contact region 564′ and being equipped with sealing means suitable for a vacuum, for example vacuum grease.

The sealing of the vacuum unit 5′ with respect to the injection unit (not shown) is achieved by means of the connecting element 51′ which comprises an O-ring 511′ for sealing purposes.

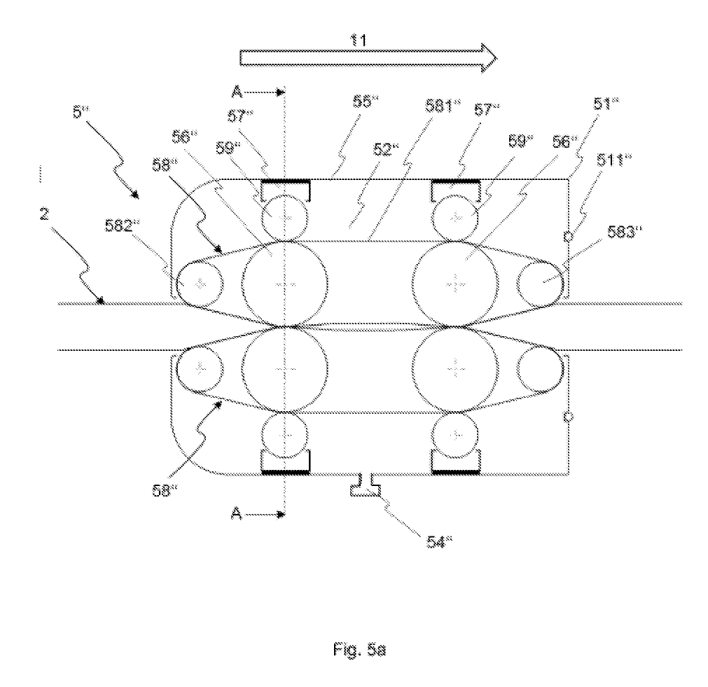

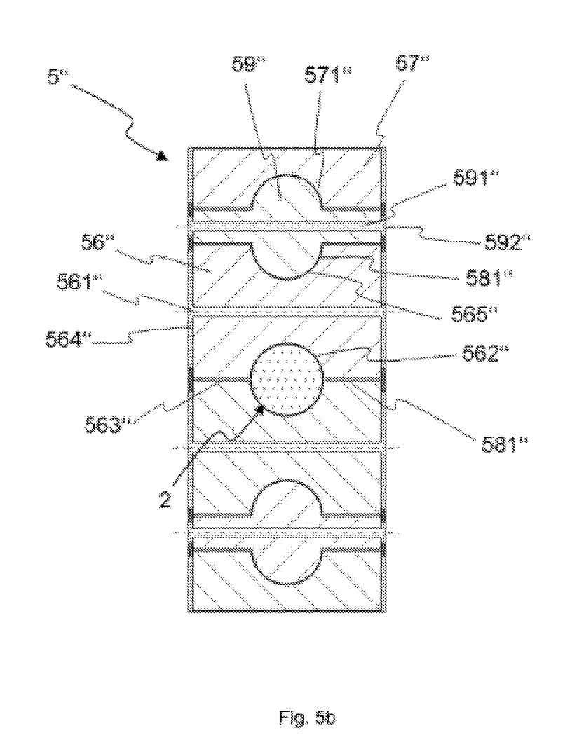

FIGS. 5a and 5b show a further alternative embodiment for a vacuum unit 5″ comprising a vacuum chamber 52″ in an airtight housing 55″ comprising a connection element, e.g. a small flange, for a vacuum pump 54″. FIG. 5a is a side view of the vacuum unit 5″ shown in the pultrusion direction 11, the side wall of the housing 55″ being removed, and FIG. 5b is a cross section through the vacuum unit 5″ perpendicularly to the pultrusion direction 11, or the plan view of a section through the vacuum unit 5″ along the line A-A shown in FIG. 5a. The components of the vacuum unit 5″ are arranged so as to be substantially symmetrical with respect to a longitudinal plane through the centre axis of the strand 2, in the pultrusion direction 11, and therefore, for reasons of clarity, mutually symmetrical components of the vacuum unit 5″ are provided with a reference sign just once in each case.

The vacuum unit 5″ comprises two arrangements 58″ that consist in each case of two rotating rollers 56″ that are arranged in succession in the pultrusion direction 11 and are interconnected in a conveyor belt-like manner by means of a sealing strip 581″ comprising a drive roller 582″ and a tensioning roller 583″. The sealing strip 581″ in the conveyor belt-like arrangement 58″ can be actively set into motion by means of the drive roller 582″, the portion of the sealing strip 581″ arranged on the strand 2 moving in the pultrusion direction 11. The vacuum chamber 52″ is located between the two rotating rollers 56″, arranged in succession, of the two conveyor belt-like arrangements 58″. In order to arrange an additional vacuum chamber upstream or downstream of the existing vacuum chamber 56″, an additional rotating roller per conveyor belt-like arrangement 58″ is to be arranged upstream or downstream of one of the two existing rotating rollers 56″ per arrangement 58″.

The rotating rollers 56″ that are rotatably mounted on a shaft 561″ are rotationally symmetrical and in the shape of a cotton reel. Two rotating rollers 56″ in each case are arranged relative to one another in the manner of half shells. The sealing strips 581″ of the arrangements 58″ are arranged in the contact region 562″ between the rotating roller 56″ and the strand and in the contact region 563″ between the rotating rollers 56″. Accordingly, contact between the strand 2 and the rotating rollers 56″ and between two rotating rollers 56″, which contact forms a sealing surface, occurs indirectly via the sealing strip 581″.

There is no sealing contact between the sealing strips 581″ of the two conveyor belt-like arrangements 58″ in the vacuum chamber 52″, and therefore air can escape from the strand in the vacuum chamber 52″.

Each rotating roller 56″ in the conveyor belt-like arrangements 58″ rolls in a sealing manner against a counter roller 59″ that is rotatably mounted on a shaft 591″, such that a sealing surface results, in the contact region 565″, between the sealing strip 581″ arranged on the rotating roller 56″ and the counter roller 59″.

Stationary sealing elements 57″ are arranged on the airtight housing 55″ of the vacuum unit 5″ in a rigid and airtight manner. A stationary sealing element 57″ comprises a region 571″ of contact with one counter roller 59″ in each case, the counter roller 59″ rolling against the stationary sealing element 57″ in the contact region 571″. The sealing of the rollers 56″, 582″, 583″, 59″ with respect to the housing 55″ is achieved in the contact region 564″, 592″ (the contact region between the drive and tensioning rollers and the housing is not shown) between the rollers 56″, 582″, 583″, 59″ and the housing 55″, the surfaces of the rollers 56″, 582″, 583″ 59″ and of the housing 55″ being ground and polished in the contact region 564″, 592″ and being equipped with sealing means suitable for a vacuum, for example vacuum grease.

The sealing of the vacuum unit 5″ with respect to the injection unit (not shown) is achieved by means of the connecting element 51″ which comprises an O-ring 511″ for sealing purposes.

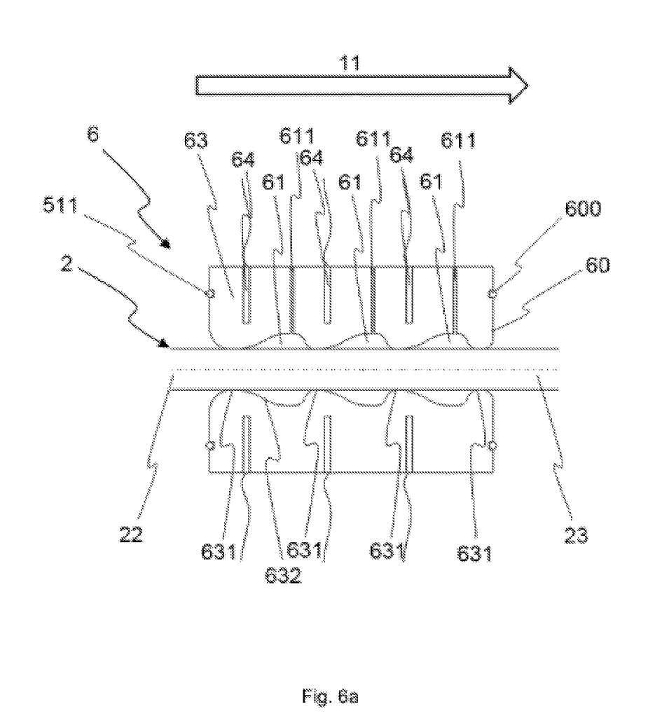

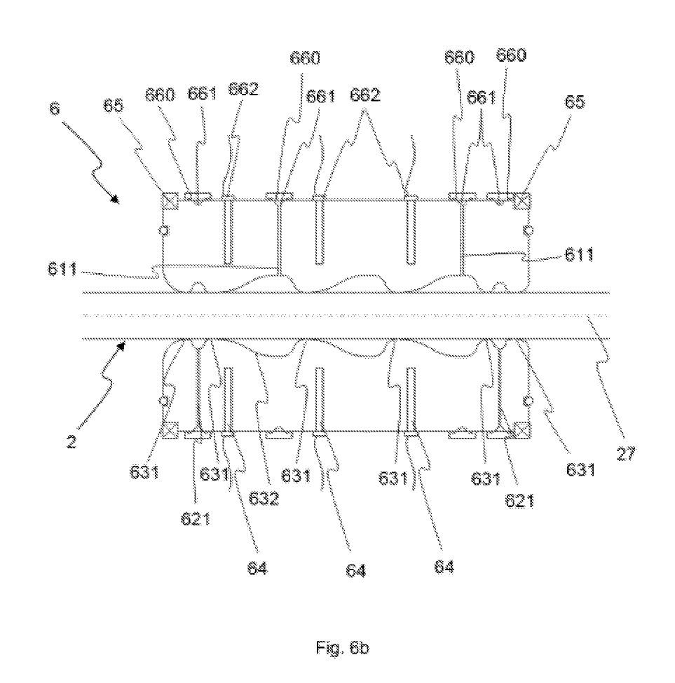

FIG. 6a is a cross section, in the pultrusion direction 11, of an embodiment of an integral injection unit 6. The components of the injection unit 6 are arranged so as to be substantially symmetrical with respect to a longitudinal plane through the centre axis of the strand 2, in the pultrusion direction 11, and therefore, for reasons of clarity, mutually symmetrical components of the injection unit 6 are provided with a reference sign just once in each case.

The strand 2 is fed to the injection unit 6, proceeding from the vacuum unit (not shown), as a virtually evacuated strand of unsaturated fibres 22, and leaves the injection unit 6 fully impregnated with matrix material, as an FRP blank 23. The injection unit 6 comprises a plurality of injection chambers 61 arranged in succession, which chambers are each connected to a reservoir for matrix material (not shown) by means of an injection channel 611. The wall 63 of the injection unit 6 is formed as a integral component, e.g. a cast part or turned part, without dividing seams. The injection chambers 61 are mutually separated by means of contact regions 631 between the wall 63 and the strand 2. As a result, matrix material can be injected into the individual injection chambers 61 at different absolute pressures, the absolute pressure generally increasing in the pultrusion direction 11 from one injection chamber 61 to the next injection chamber 61 in the pultrusion direction 11. In this case, it is expedient for the absolute pressure of the injection into the first injection chamber 61 to be selected so as to be low enough to prevent, by means of the pressure difference, the matrix material from penetrating into the vacuum unit (not shown) which is arranged upstream of the injection unit 6 and is connected thereto by means of a seal provided with an O-ring 511.

Owing to the friction present in the contact regions 631, the strand channel is provided with a preferably break-free wear protection layer (not shown) in the contact regions 631 and over the entire inner surface 632 of the wall 63.

A plurality of temperature-control elements 64 are arranged on the injection unit 6 in order for it to be possible to influence the temperature-dependent viscosity of the matrix material in a desired manner. In this case, the temperature-control elements may be used for heating or cooling and may be for example resistance heaters or heating cartridges or coolant channels or electrical cooling elements.

The injection unit 6 is sealed off with respect to a coating unit (not shown) that follows in the pultrusion direction 11, by means of an O-ring 600 and a suitable connecting element 60 such as a flange element or connecting element.

An integral injection unit 6 can be manufactured for example by means of hollow turning or erosion of solid material. Cleaning baths, for example, can be used for cleaning.

FIG. 6b shows an integral injection unit 6, similar to that in FIG. 6a, drive elements 65 being arranged on the injection unit 6 in order for it to be possible to perform a rotation of the injection unit 6 about the strand axis 27. The strand 2 is designed so as to be rotationally symmetrical about the strand axis 27. The rotation prevents possible accumulation of the fibres on the surface of the strand 2 in the entry region into the respective contact regions 631 between the inner surface 632 and the strand 2. The stationary matrix reservoir (not shown) is connected to the co-rotating injection channels 611 and drainage channels 621 arranged on the drainage chambers 62 by means of rotary unions 660 that are arranged on a peripheral groove 661. The electrical power is transmitted to the temperature-control elements 64, in the form of electric heaters, for example by means of sliding contacts 662.

Owing to the friction in the entry region into the contact region, the rotational movement is transmitted to the fibres on the surface of the strand in part. The translational movement and the rotational movement result in a force on the fibres on the surface of the strand. Said resulting force causes a slight displacement of the fibres on the surface of the strand, which displacement promotes constriction of the strand and thus reduces the diameter of the strand, as a result of which the fibres are subjected to additional tensile stress.

The constriction-promoting effect of the resulting force on a fibre on the strand surface is present apart from in the case in which the direction of the resulting force corresponds to the fibre direction vector in the relevant associated defined point of the entry region into the contact region. In this case the fibre direction vector corresponds to the unit vector, the direction of which reflects the orientation of the fibres on the strand surface. The rotational speed should therefore preferably be selected such that the situation described above does not arise, at least in the case of most of the defined points. Particularly preferably, the rotational speed should be selected such that the situation described above does not arise in the case of more than 80% of the defined points. Said rotational speed or said rotational speeds should be excluded from the range available for the selection of the rotational speed, which range comprises all speeds which cause a resulting force to occur on the fibres on the strand surface.

In this case, the reduction in the diameter of the strand owing to the resulting force is very small compared with the diameter of the strand. After leaving the contact region, the displacement of the fibres is almost completely reversed again by restoring forces owing to the tensile stress. The rotational movement thus at least does not change target geometry of the strand to an inadmissible extent.

The described embodiment is advantageous in that an accumulation of fibres on the surface of the strand, in the entry region into the elements of the vacuum unit and/or of the injection unit which comprise a region of contact with the strand, is at least significantly reduced.

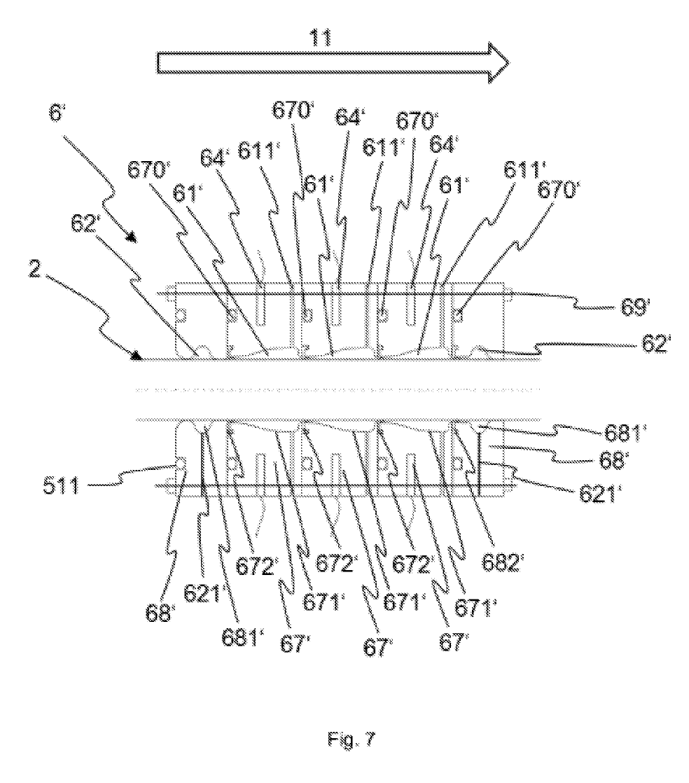

FIG. 7 is a cross section, in the pultrusion direction 11, of an alternative embodiment of a modular injection unit 6′. The components of the injection unit 6′ are arranged so as to be substantially symmetrical with respect to a longitudinal plane through the centre axis of the strand 2, in the pultrusion direction 11, and therefore, for reasons of clarity, mutually symmetrical components of the injection unit 6′ are provided with a reference sign just once in each case.

The injection unit 6′ is in a modular construction, consisting of a plurality of mutually separated modules 67′, 68′. The number of modules 67′, 68′ can be selected and adjusted in a simple manner, in accordance with the process parameters of the process according to the invention. In each case, two modules 67′, or one module 67′ and one module 68′, are sealed off with respect to the surroundings of the injection unit 6′ by means of an O-ring 670′ and by means of clamping all of the modules 67′, 68′ using clamping elements 69′. The inner surface 671′ of a module 67′ is shaped such that a cavity forms around the strand 2, as the injection chamber 61′. Each injection chamber 61′ comprises injection channels 611′ which are connected to a reservoir for matrix material (not shown). The inner surface 681′ of a module 68′ is shaped such that a cavity forms around the strand 2, as the drainage chamber 62′. Each drainage chamber 62′ comprises a drainage channel 621′ which is connected to an outlet gulley (not shown) for excess matrix material. In each case, a drainage module 68′ is arranged upstream and downstream of the number of injection modules 67′ selected in a manner matched to the process parameters. It is also possible to insert modules into the arrangement that function as inactive chambers. A temperature-control element 64′, e.g. in the form of an electrical heater, is arranged on each injection module 67′ in order to influence the viscosity properties of the matrix material by means of purposeful temperature adjustment.

The modules 67′, 68′ are sealed off with respect to one another by means of sealing elements 672′, 682′, for example elastomer sealing lips, which are oriented in the pultrusion direction 11 owing to the directed movement of the strand 2 through the strand channel, and are pressed against the strand 2 in a sealing manner by means of the positive relative pressure prevailing in the injection chambers 67′. Owing to the modular construction of the injection unit 6′, the sealing elements 672′, 682′ can be exchanged in a simple manner if said elements are worn and the sealing effect decreases due to abrasion owing to the movement of the strand 2.

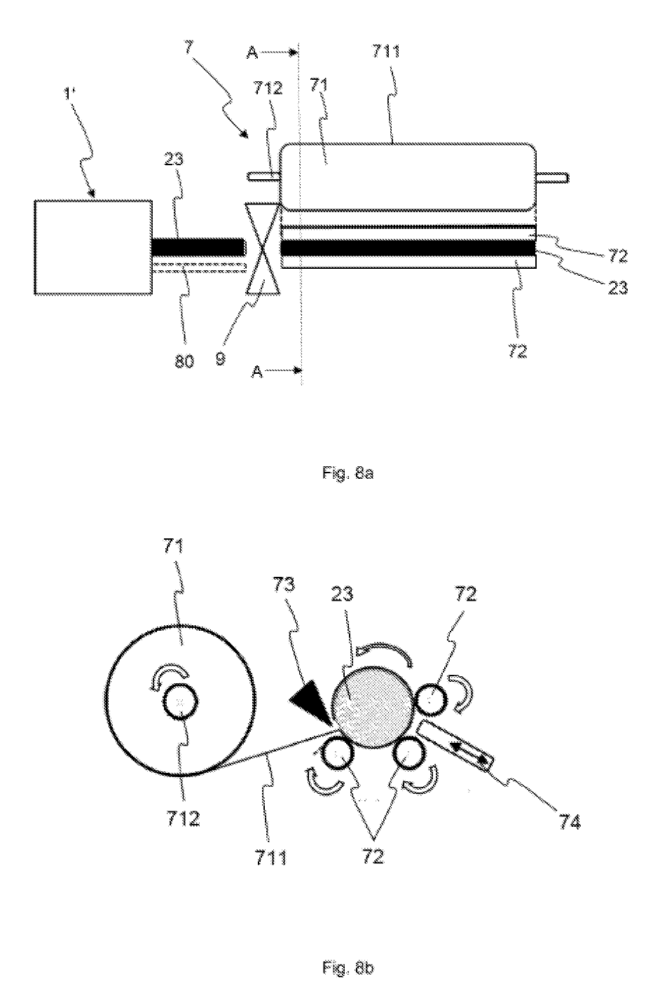

FIGS. 8a and 8b show an embodiment of a coating unit 7, FIG. 8a being a plan view and FIG. 8b showing the cross sectional view shown in FIG. 8a, along the line A-A. The surface of the FRP blank 23 is coated by means of being rolled up in a film 711 from a film storage means 71 that is axially parallel with the FRP blank 23 and is rotatably mounted on a shaft 712. The film feed takes place over the entire length of the FRP blank 23; the width of the film 711, i.e. the dimension thereof in parallel with the shaft 712, corresponds at least to the length of the FRP blank 23. The film 711 is drawn off from the film storage means 71 and introduced, into a guided manner, into a region in which a plurality of rollers 72 are rotatably arranged.

The FRP blank 23 leaves the pultrusion facility 1′ fully impregnated with matrix material and is transported by a conveyor belt 80 to the cutting unit 9, e.g. a saw, and cut to length. After being cut to length, the FRP blank 23 is also transported, in a freely suspended manner, into the roller region, and the film 711 is pressed onto the surface in a portion of the surface of the FRP blank 23. Rotation of the rollers 72 in the direction of rotation indicated by arrows in FIG. 7b causes the FRP blank 23 to rotate in the opposing direction of rotation shown. The film storage means 71 thus also rotates in this direction of rotation that opposes the rollers 72, and therefore the film 711 is drawn further into the roller region and is laid completely around the surface of the FRP blank 23, until a slight overlap is achieved. In order to seal the overlap, the film 711 may be self-adhesive for example. Subsequently, the film 711 is trimmed by the tool 73 and laid on the surface of the FRP blank 23 in a crease-free and rigid manner by means of further rotation of the rollers 72 and of the FRP blank 23. The coated FRP blank is removed from the roller region by means of an ejector 74.

### LIST OF REFERENCE NUMERALS

1, 1′ pultrusion facility
2 strand
200 air bubbles
21 strand of unsaturated fibres
22 virtually evacuated strand of unsaturated fibres
23 FRP blank
230 matrix material
24 FRP blank comprising a coating
25 mould core
26 dimensions of the strand
27 strand axis
3 supply region
31 creel
310 spool
311 roving
32 winding wheel
321 roving
33 fibre strip spool
331 fibre strip
4 guide unit
5, 5′, 5″ vacuum unit
500 drive element for rotation
51, 51′, 51″ connecting element
511, 511′, 511″ O-ring
512 contact region
513 dimension of the strand channel in the contact region
52, 52′, 52″ vacuum chamber
520 inactive chamber
53 stationary annular element
531 contact region between the stationary annular element and the strand
532 inner surface of a stationary annular element
533 O-ring
534 dimension of the strand channel in the contact region
535 clamping element
54, 54′, 54″ connection element for a vacuum pump
541 rotary union
542 groove
55′, 55″ housing of the vacuum unit
56′, 56″ rotating roller
561′, 561″ shaft of the rotating roller
562′, 562″ contact region between the rotating roller and the strand
563′, 563″ contact region between two rotating rollers
564′, 564″ contact region between the rotating roller and the housing
565″ contact region between the rotating roller and a counter roller
57′, 57″ stationary sealing element
571′, 571″ contact region between the stationary sealing element and a roller
58″ conveyor belt-like arrangement
581″ sealing strip
582″ drive roller
583″ tensioning roller
59″ counter roller
591″ shaft of the counter roller
592″ contact region between the counter roller and the housing
6, 6′ injection unit
60 connecting element
600, 600′ O-ring
61, 61′ injection chamber
611, 611′ injection channel
62, 62′ drainage chamber
621, 621′ drainage channel
63 wall
631 contact region between the wall and the strand
632 inner surface of the wall
64, 64′ temperature-control element
65 drive element for rotation
660 rotary union
661 sliding contact
662 groove
67′ injection module
670′ O-ring
671′ inner surface of the injection module
672′ sealing element
68′ drainage module
681′ inner surface of the drainage module
682′ sealing element
69′ clamping element
7 coating unit
71 film storage means
711 film
712 shaft of the film storage means
72 rollers
73 tool for film trimming
74 ejector
8 strip draw-off unit
80 conveyor belt
9 cutting unit

1. Pultrusion process for the continuous production of blanks from fibre-reinforced plastics composite material (23), comprising at least the following process steps:
i. providing a strand of unsaturated fibres (21);
ii. feeding the strand of unsaturated fibres (21) to a vacuum unit (5, 5′, 5″) that comprises at least one vacuum chamber (52, 52′, 52″);
iii. generating a negative relative pressure in the at least one vacuum chamber (52, 52′, 52″) of the vacuum unit (5, 5′, 5″), as a result of which air (200) escapes from the strand of unsaturated fibres (21);
iv. removing the virtually evacuated strand of unsaturated fibres (22) from the vacuum unit (5, 5′, 5″) and feeding the virtually evacuated strand of unsaturated fibres (22) to an injection unit (6, 6′) that comprises at least one injection chamber (61, 61′), the vacuum unit (5, 5′, 5″) and injection unit (6, 6′) being interconnected so as to be airtight at least with respect to the surroundings;
v. injecting matrix material (230), in fluid state, into the at least one injection chamber (61, 61′) of the injection unit (6, 6′), and impregnating the strand (2) with the matrix material (230);
vi. removing the blank (23) from the injection unit (6, 6′).

2. Pultrusion process according to claim 1, characterised in that the following process steps follow process step vi.:
vii. feeding the blank (23) to a coating unit (7);
viii. forming a coated surface of the blank (23) in the coating unit (7), the coating (711) being designed to ensure the air tightness of the surface during further process steps which the blank (24) may undergo;
ix. removing the blank (24), comprising the coating, from the coating unit (7).

3. Pultrusion process according to claim 1, characterised in that either, following process step vi., the blank (23), or, following process step ix., the blank (24) comprising a coating, passes through a cutting unit (9), the blank (23) or the blank (24) comprising a coating being cut to length in the cutting unit (9).

4. Pultrusion process according to claim 1, characterised in that the strand channel of the vacuum unit (5) comprises a friction-reducing surface.

5. Pultrusion process according to claim 1, characterised in that the vacuum unit (5, 5′) comprises at least two chambers (52, 520, 52′) that are interconnected in an airtight manner.

6. Pultrusion process according to claim 1, characterised in that the vacuum unit (5, 5′) comprises at least one annular element (53) that is arranged in a stationary manner around the strand of unsaturated fibres (21), or comprises rotating roller seal elements (56′).

7. Pultrusion process according to claim 1, characterised in that the vacuum unit (5″) comprises at least two arrangements (58″) of rotating roller seal elements (56″), at least two rotating roller seal elements (56″) arranged in succession in the pultrusion direction (11) being interconnected, in one arrangement (58″), in the manner of a conveyor belt, by means of a sealing strip (581″).

8. Pultrusion process according to claim 1, characterised in that the injection unit (6, 6′) comprises at least two chambers (61, 61′, 62, 62′) that are interconnected so as to be airtight at least with respect to the surroundings.

9. Pultrusion process according to claim 1, characterised in that the injection unit (6, 6′) comprises at least one drainage chamber (62, 62′) that is arranged upstream and/or downstream of the at least one injection chamber (61, 61′) and/or between two chambers (61, 61′) of the injection unit (6, 6′).

10. Pultrusion process according to claim 1, characterised in that the injection unit (6) is formed as an integral component.

11. Pultrusion process according to claim 1, characterised in that the injection unit (6′) is formed as a modular component, the modules (67′, 68′) of the injection unit (6′) being interconnected so as to be airtight at least with respect to the surroundings.

12. Pultrusion process according to claim 1, characterised in that the strand channel of the injection unit (6, 6′) is provided with a wear protection layer.

13. Pultrusion process according to claim 1, characterised in that at least one temperature-control element (64, 64′) is arranged on the injection unit (6, 6′).

14. Pultrusion process according to claim 1, characterised in that at least the elements of the vacuum unit (5) and/or of the injection unit (6) which have a region (531, 631) of contact with the strand (2) perform a rotational movement around the strand (2), the strand (2) being rotationally symmetrical about a strand axis (27).

15. Pultrusion process according to claim 2, characterised in that the injection unit (6, 6′) and the coating unit (7) are interconnected so as to be airtight at least with respect to the surroundings.

16. Pultrusion process according to claim 2, characterised in that a coated surface of the blank (23) is formed by means of partial consolidation of matrix material (230) in regions close to the surface, or by means of cooling regions close to the surface to a temperature that is lower than or equal to the glass transition temperature of the matrix material (230), at a sufficiently high cooling rate.

17. Pultrusion process according to claim 2, characterised in that a coated surface of the blank (23) is formed by means of a sprinkling unit or an immersion bath or an extruder, or by means of wrapping or encasing the blank in a film (711), or by means of rolling up the blank in a film (711).

18. Arrangement for carrying out a pultrusion process for the continuous production of blanks from fibre-reinforced plastics composite material (23), comprising:
a vacuum unit (5, 5′, 5″) that comprises at least one vacuum chamber (52, 52′, 52″), the vacuum unit (5, 5′, 5″) comprising at least one connection element (54, 54′, 54″) that is suitable for connecting a vacuum pump, and the vacuum unit (5, 5′, 5″) being designed such that a negative relative pressure is generated in a strand of unsaturated fibres (21), and
an injection unit (6, 6′) comprising at least one injection chamber (61, 61′) for injecting matrix material (230), in a fluid state, which injection chamber is designed for impregnating the strand (2) with the matrix material (230),
the vacuum unit (5, 5′, 5″) being arranged upstream of the injection unit (6, 6′) in the pultrusion direction (11).

19. Arrangement for carrying out a pultrusion process for the continuous production of blanks from fibre-reinforced plastics composite material (24) according to claim 18, characterised in that the arrangement comprises elements (500, 65) which are designed to set the vacuum unit (5) and/or the injection unit (6) or at least the elements of the vacuum unit (5) and/or of the injection unit (6) which have a region (531, 631) of contact with the strand (2), into a rotational movement around the strand (2).

20. Arrangement for carrying out a pultrusion process for the continuous production of blanks from fibre-reinforced plastics composite material (24) according to claim 18, characterised in that a coating unit (7) is arranged downstream of the injection unit (6, 6′) in the pultrusion direction (11).

21. (canceled)

22. (canceled)
